(19) United States
(12) Patent Application Publication
(10) Pub. No.: US 2013/0297403 A1
(43) Pub. Date: Nov. 7, 2013

(54) MARKETING BASED DISCOUNTS AND LOCAL HEAT CLOUDS

(71) Applicant: Gregory P. Manning, New York, NY (US)

(72) Inventor: Gregory P. Manning, New York, NY (US)

(21) Appl. No.: 13/855,696

(22) Filed: Apr. 2, 2013

Related U.S. Application Data
(60) Provisional application No. 61/619,105, filed on Apr. 2, 2012.
(60) Provisional application No. 61/791,992, filed on Mar. 15, 2013.

(51) Int. Cl. G06Q 30/02

(52) U.S. Cl. CPC G06Q 30/0239
USPC 705/14.39

(57) ABSTRACT

The present invention discloses methods, systems, and technologies leveraging the capabilities of digital device, e-commerce, and social media technologies to expand the product choices and price options available to each purchaser of a product or service, while also increasing the marketing capabilities and general product awareness of creative content in both physical and digital environments.

### CROSS-REFERENCE TO RELATED APPLICATIONS

The present application claims priority to U.S. Provisional Application Nos. 61/619,105 filed Apr. 2, 2012 and 61/791,992 filed Mar. 15, 2013, the contents of both provisional applications are herein incorporated by reference in their entireties.

### FIELD OF THE INVENTION

The present application relates to digital content distribution and expansion of product choices and price options by leveraging the capabilities of digital device technology.

### BACKGROUND

e-books form an increasing share of the market for fiction and non-fiction books, following a pattern previously seen in the music and motion picture content industries, where the digitization of content removed the container from economic equation, materially restructuring the economic models for those industries.

Global distribution and marketing of creative content heretofore required the ability to print and then ship large quantities of physical units to numerous locations where they could be physically purchased by consumers. By virtue of having the capital to perform such manufacturing and distribution, publishers were in a position to pick whom to publish, and whom to promote. Modern digital networks permit the instant global distribution of digital content substantially for free. Individual artists no longer needed publishers to manufacture or distribute units of their copyrighted material, and saw the rise of a digital distribution model for creative content.

The dominant entities in this new model were the makers of the digital devices that increasingly serve as the physical interface for content consumption, who gained disproportionate control over retail sale and pricing to consumers. For example, in launching the iTunes store to support its iPod music player, Apple prevailed upon a music industry built around the sale of albums to embrace a model whereby individual song files could be sold for 99 cents each. In another example, under the wholesale model of e-book distribution, Amazon was able to pay the full wholesale price for an e-book, then heavily discount the e-book's retail price to make the incremental purchase of e-books relatively attractive after the initial purchase of a Kindle. Other retailers who did not have an income stream linked to e-reader devices were at a comparative disadvantage. Subsequently, in support of its iPad, Apple promulgated an agency model for e-book pricing, whereby e-books were sold at a single price through all online retail channels, and the retailer took a percentage of the gross price, limiting the ability to discount e-book sales in favor of hardware sales. The agency model resulted in higher prices for e-books generally, increasing costs to consumers. The e-book agency pricing model is notably being examined for anti-trust issues by various governmental bodies.

Social media have become a major component of Internet content. However, much social media content is posted voluntarily by users, and as a result, in general there are few reliable models to generate revenue from such voluntary contributed data. Advertising linked to such data has been questioned for its effectiveness, since users visit social media sites not necessarily to shop but to, in effect, socialize. Economic activity is not a driving force of the data nor is it a necessary consequence of social interaction.

Accordingly, there is a need for a computer based system and program controlled method that implements a purchasing/marketing program that modulates cost/price in accordance with select plan dictates.

### SUMMARY OF THE INVENTION

The present invention is directed to computer implemented and/or other electronically recorded transactions wherein a program controlled processor determines a select price for purchased goods or services that is discounted from retail through an exchange operation with the consumer either at the time of sale or within an authorized period subsequent to sale. In particular, the present invention supports pricing algorithms that allow for continued consumer monitoring to effect a lower initial price. To illustrate one aspect, certain privacy rights can be surrendered in exchange for a discounted price for digital content, digital or physical goods and/or services.

### BRIEF DESCRIPTION OF THE DRAWINGS

FIG. 1 is a flow chart of YouBoard purchase and fulfillment in accordance with certain embodiments of the present invention.

FIG. 2 is a graphic depiction of YouBoard fulfillment in accordance with certain embodiments of the present invention.

FIG. 3 is a flow chart of YouBoard fulfillment in accordance with certain embodiments of the present invention.

FIG. 4 is a listing of YouBoard capabilities and YouBoard triggers in accordance with certain embodiments of the present invention.

FIG. 5 is flow chart of Velocity Cloud Formation in accordance with certain embodiments of the present invention.

FIGS. 6-10 are examples of YouBoard account templates and purchase events in accordance with certain embodiments of the present invention.

### DETAILED DESCRIPTION OF THE INVENTION

The present application therefore provides methods, systems, and technologies leveraging the capabilities of digital device technology to expand the product choices and price options available to each purchaser of a digital product, while also increasing the marketing capabilities and general product awareness of creative content in both physical and digital environments. Publishers may rebuild an important form of visual local marketing; device manufacturers may see renewed opportunities to sell digital devices with technology capable of applying such economies to consumers, and consumers may welcome open-term options to pay lower prices.

Such methods and technologies may include Marketing-Based Discounts (“MBDs”) and Marketing-Based Discount Technology (“MBD Technology”) which separately and together may permit, authorize, enable, or otherwise facilitate the purchase and/or subsequent usage or resale of a good or service with one or more such MBDs, exercisable at the customer's option and of greater or lesser value, reflecting varying levels of disclosure and post-purchase marketing and promotional services to be provided, being applied to the purchase price. The MBD Technology may thus be seen as leveraging the capabilities of computer software, database, and digital communications and device technologies to permit the buyer to alter the nature of the digital product, digitally capable product or physical product being purchased, at the time of purchase or subsequently, such that the product being purchased may be individuated ads to future economic potential, visibility, private and public branding, or any other characteristics. Such MBD- or MBD Technology derived pricing models and product alterations may be applied to the sale of periodical digital and video content, as well as to digitally capable physical products, physical products or hard goods, and services.

Notably, the optional elections enhance the quality of the product to the consumer while lowering the price to the consumer. Unlike the typical customization of a product, for example an automobile, where each option or enhancements that may be selected typically would entail an additional cost, raising the purchase price, the customization choices made through use of the MBD Technology may reduce the cost to the purchaser of the good or service, either at the time of purchase or via exercise of available MBDs subsequent to purchase for the purchased item, by incorporating into the purchase of the good or service the commitment by the purchaser to fulfill the terms of the specific MBD the purchaser selected, which may include any from among a wide range of subsequent promotional, marketing, and/or advertising obligations with respect to the purchase or subsequent usage in a manner that may beneficially serve a seller's marketing interest.

Marketing-Based Discounts (“MBDs”) may be offered as a solution for the direct monetization of consumer purchase information and social media posts. The Marketing-Based Discounts technology may compensate the consumer and benefit the seller. In exchange for posting agreed data about their purchase and subsequent use of MBD-covered goods and services, consumers may have the option within MBD-covered transactions to realize a direct discount at the time of sale.

From purchase onward through each use of an MBD-covered item, such as opening an eBook, the MBD technology may generate real-time social data to be aggregated and displayed by electronic or online databases and services such as YouBoard™, an exemplary e-commerce and social media billboard platform. YouBoard's purchase interface may present MBDs for exercise as clickthrough options at final checkout. YouBoard may then serve as the secure repository for the database of realized MBDs, as well as the engine for MBD fulfillment, generating fresh postings on actual purchases and actual product usage. YouBoard's message:

YouBoard may vest consumers with discretionary control over incremental decisions to share their private data, and by doing so may furnish a substantive model to compensate consumers for the business use of their personal information. The prospect of regular compensation may supply motivation, heretofore absent, for consumers to build and maintain online personal data lockers.

U.S. credit and debit card transactions in 2010 exceeded $3 trillion. (Federal Reserve System, 2011 (Updated)) If MBD-covered transactions reached 5.0% market penetration, projected consumer incentives may top $8 billion, with projected license fees above $400 million. At 7.5% market penetration, projected consumer benefits top $24 billion, with $1.4 billion in license fees. (Table 4)

The MBD Technology may be seen as introducing an additional layer of revenues that are separate and distinct from the traditional buying and selling cash flows of e-commerce and may exist as new channels for earning income from current sales, as well as new incentive channels to drive consumers to execute an incremental new layer of purchase activity. Beyond embedding revenues into social media data through license fees payable for the administration and auditing of YouBoard incentive contracts, through its incremental addition of purchase incentive the MBD technology may become an important engine driving and/or accelerating widespread consumer adoption of digital wallets and mobile payments. Retail incentives linked to social interaction may prove capable of driving the highest levels of user engagement by incorporating tangible monetary and associative benefits to actions that are currently asked of consumers for no compensation, such as post-purchase sharing on Amazon, or actively “Pinning” a consumer preference to Pinterest. Through these tangible consumer benefits, YouBoard may prove an effective means to invite increased participation from a social population of billions of shoppers who may be pointed toward YouBoard's services within every MBD-covered transaction.

Heretofore, companies such as Google and Facebook have achieved significant market penetration by providing free services to pursue large scale adoption with eyes toward an advertising-driven revenue model, and in Google's case at least, monetization of enhanced services in support of those basic functions. One of Facebook's central promotional tenets is, “It's free and always will be,” but this may also be seen as a declaration that the value or benefit of the service being provided to the consumer by Facebook may be of equivalent value, and in fact Facebook's policies are notable because the Facebook agreement provides for the account opened by an individual being Facebook's property, meaning that the value of a consumer's private information is being passed to Facebook for no compensation. However, the main purpose of providing free services is to remove the price barrier to entry to the consumer service agreement. This initial free service then faces the challenge of monetization, attempting to extract fees or payments from a customer who initially contracted to receive a free service. Under the YouBoard model, the economics shift, in part because there are already fees and payments involved, and the consumer may be seen as being compensated through a discount to those fees for waiving privacy for specific electronic or electronically recordable events, but also in part for providing ongoing services to the seller, which may be seen as being equivalent to the discount that is being provided via the YouBoard technology. The YouBoard model may also be viewed as being distinct from the e-commerce model of Amazon because of such service being provided, and because of the unknown future economic events that will result from the consumer's economic decision at the time of purchasing the MBD-covered good or service. The very nature of the retail transaction is altered, leading to unique product identities; tangible consumer savings; ongoing consumer-to-seller services that are quantifiable, compensated, and explicit; licensed social media data; privacy-waived consumption data; and a potential wealth of explicit big data accessible broadly to consumers and businesses as valid metrics or real economic activity, with potential consequences for a broad measure of commercial and financial activities including capital planning, investment, and management of household incomes and consumption.

In various embodiments, individually purchased goods and/or services may have fixed copyrighted, trademarked, and/or contractually mandated content but may be permitted to have variable potential commercial identities presentable to the consumer for consideration during the search and purchase processes, and activated by the consumer subsequent to the purchase of the good or service, based on the choices made by such purchaser from among the available MBDs, or from among MBDs that in certain circumstances may be proposed by the purchaser or purchasers. The YouBoard Technology may be seen as changing the nature of what a digital product, hybrid physical/digital product, physical product, and digital or physical service is, or is capable of becoming..

In one embodiment, the purchaser may be entitled to take advantage of certain discounts at the time of purchase, at their discretion, by choosing to meet certain criteria. These may be seen collectively as MBDs or YouBoard discounts. The price for an e-book or digital music file may thus be beneficially discounted at a series of levels meeting different discount, purchase, and or post/sale fulfillment criteria, and each discount level may have tiers within it, depending on the form by which the discount is implemented.

In one embodiment, disclosed in U.S. provisional application 61/619,105 filed Apr. 2, 2012, which is incorporated by reference, retail purchasers may choose to receive a discounted retail price in exchange for agreeing to broadcast or post their purchase of the specific product embodied in the specific retail transaction, and in addition may also agree to generate automatic posts when the product is used, or to provide external displays of the product being used (for example, an exterior cover displayed for the eBook being read on a multiscreen tablet) in exchange for agreeing to the terms of a specific discount level. Such discounted price may be defined as the “YouBoard Price,” “YB Price,” or “YBP.” Notably, in agreeing to the discount, the retail purchaser may also agree that the specific data that is agreed to be broadcast with respect to that specific purchase and according to the specific terms of the agreed discount is not private data and that such display is previously and explicitly approved, in exchange for the contractual consideration represented by the discount. Privacy may thus be managed through an explicit contract with exchange of consideration. Such pre-approved data generated by agreeing to the terms of a Marketing-Based Discount (“MBD”) may be defined as “MBD Data.” Use of such MBD Data may be in full compliance with privacy regulations such as those being contemplated by various government regulators in which a user would be required to approve the display and subsequent use of their voluntarily contributed social data, otherwise described as choosing to “opt in” to the display of such data.

In one embodiment usage may also be generated through temporary access or use of digital content including periodical content, eBooks, video and audio. Such temporary access may be accomplished through a Location Based Subscription (“LBS”) undertaken by the individual, or as provided by a local virtual newsstand making such content available for a limited charge for such limited time in such defined location to users in that location for the duration of their time in that location, as disclosed in U.S. patent application Ser. No. 13/053,163 filed Mar. 21, 2011, entitled Location Based Electronic Reader Services For Waiting Rooms, incorporated herein by reference. Data generated by such temporary consumption at defined physical location such as an airports or waiting rooms, online location, or virtual location defined as a group, area, or other criterion, may be described as “LBS Data.”

MBD and LBS Data may be aggregated and reported and displayed and made available for full searching and processing and social media sharing on an online or licensed electronic bulletin board that may be described by the trademarked commercial term “YouBoard.” YouBoard may broadcast such information as well as build and maintain datasets of all such data received. Collectively, MBD and LBS Data displayed on YouBoard may be described as YouBoard Data (“YB Data” or “YBD”).

In return for maintaining the database of YB Data the entity providing the MBBs may be paid a license fee equal to, for example, 6 percent of the realized MBDs and LBS fees underlying the YB Data. Such YB license fees and related discounts may be seen as privacy management expenses, with explicit fees granting buyers and seller explicit rights.

YB Data may be real-time, cross-product consumption tables reported in real-time and searchable by consumer, business, and government users as well as others in granular measurements of MBD Data, LBS Data, or collectively as YB Data in modular building blocks from a local hotspot, to neighborhoods, to schools or universities, to airports, to cities. YB Data may potentially display the aggregated or any community that may be objectively defined.

One consequence of the creation of YB Data from MBDs and LBS activity is the direct generation of allocable consumer incentives in the form of monetized discounts, as well as new revenue related to consumer economic activity, e-commerce transactions, and the payment of license fees or service fees for the administration and management of databases of such revenues, including the generation of revenue and payment streams according to the terms of the MBDs, LBS, license or administrative pay agreements or any other economic agreement that may be contemplated to govern, manage, or administer such YB transactions and YB Data events. Such revenues, payments, and fees may be defined as YB Incentives and YB Monies.

Various technologies and methods may be contemplated for the delivery and exploitation of such YB Data, YB Incentives, and YB Monies. YouBoard may be envisioned as a real-time, self-monetizing revenue model for social data streams, one that may propel the adoption of mobile payment platforms while creating a new mode for consumer to consumer advertising.

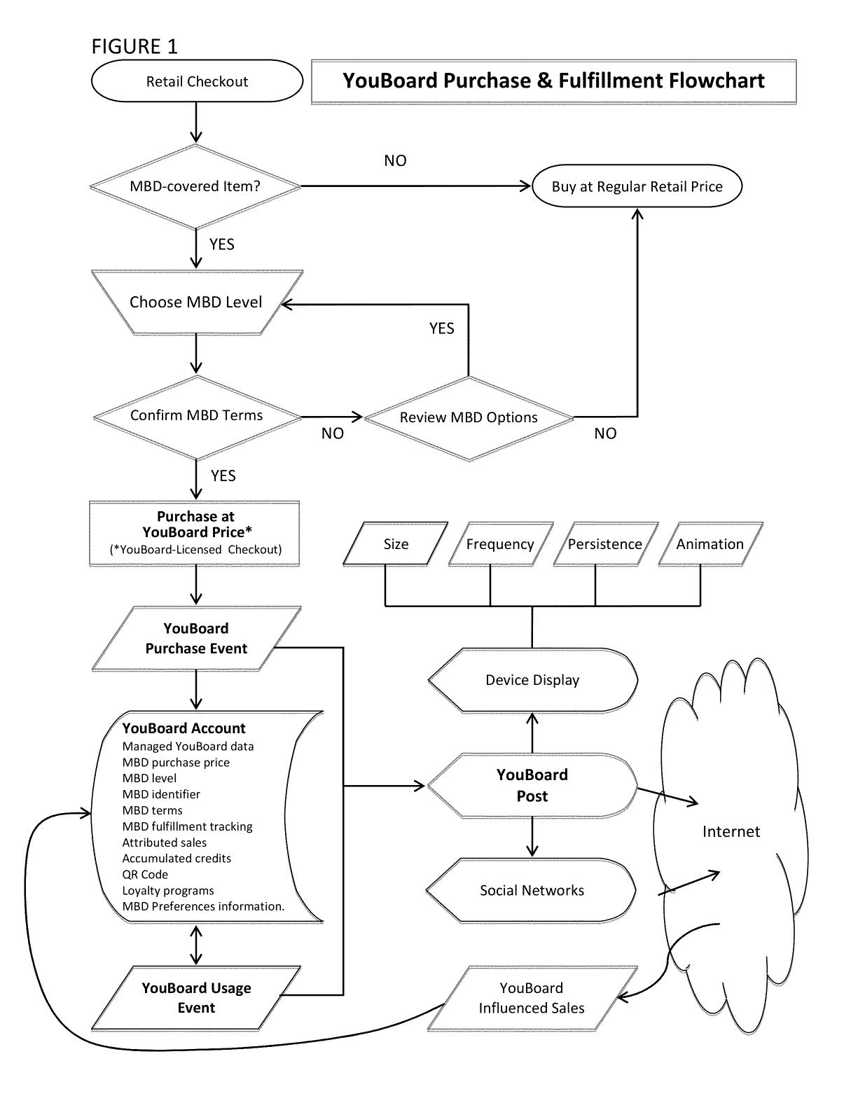

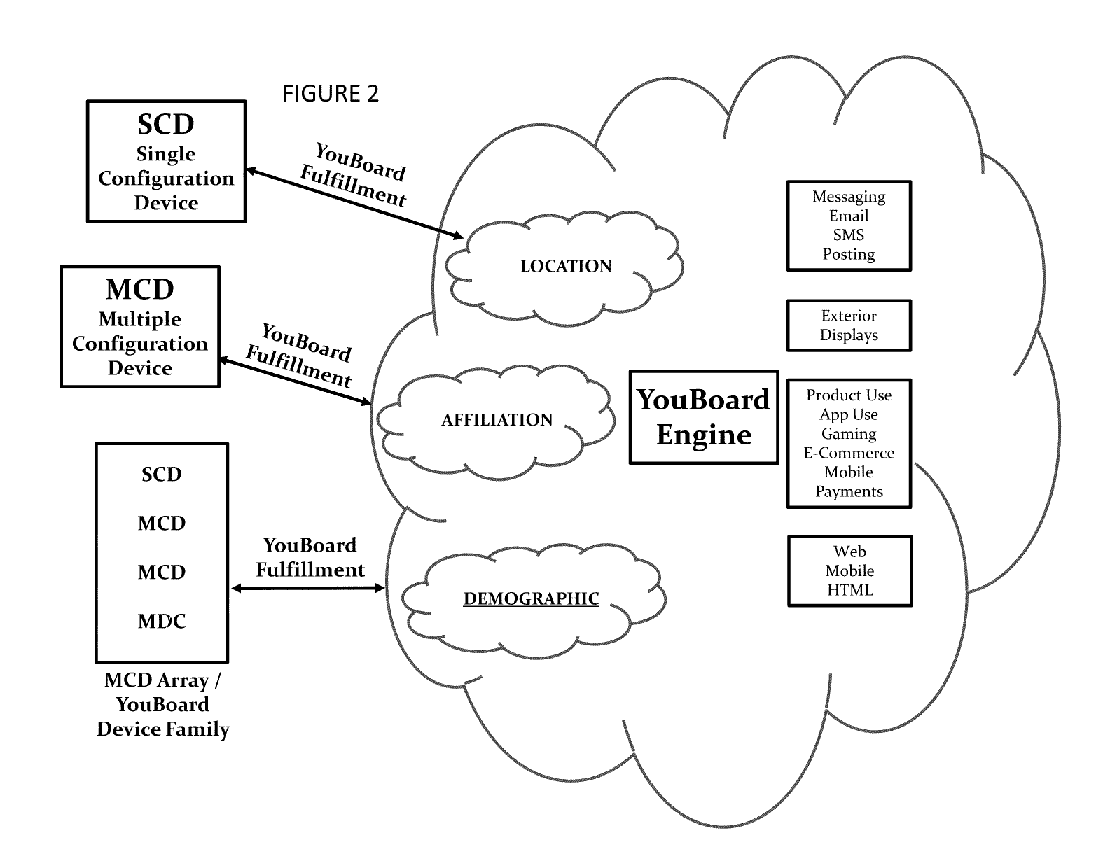

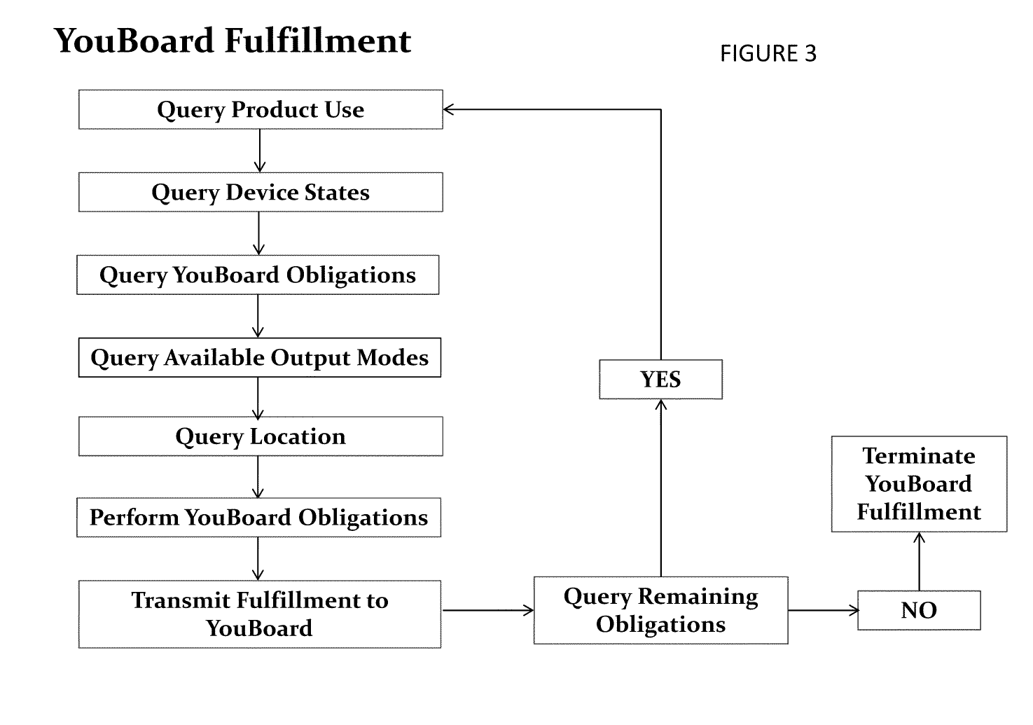

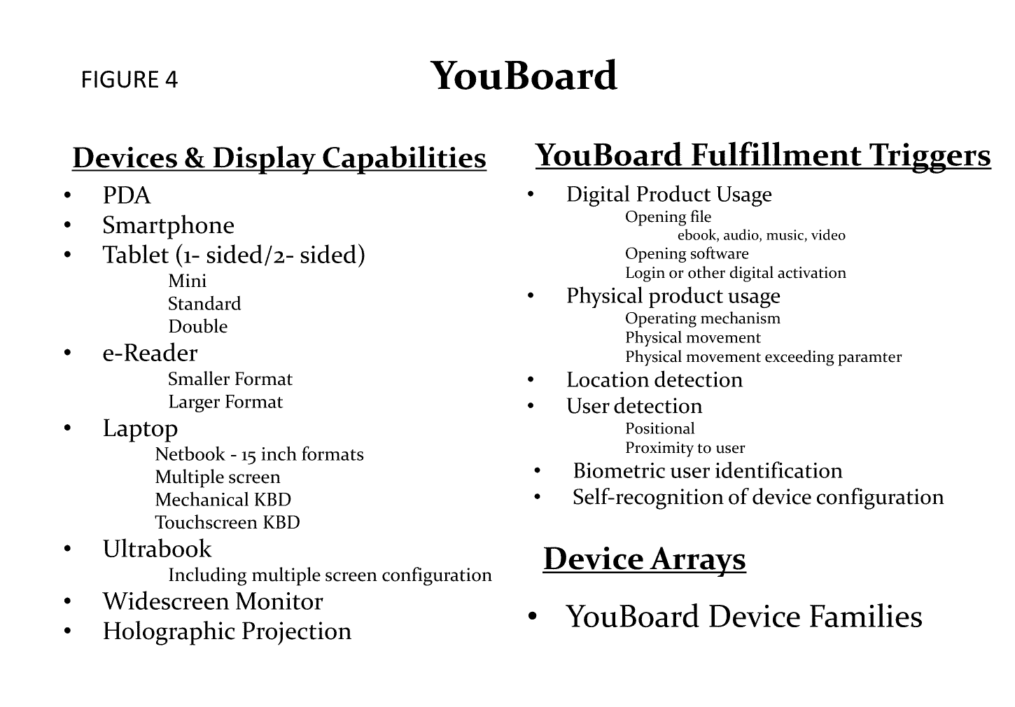

The foregoing system operations utilize a network based communication approach, employing standard Internet protocols such as TCP/IP and support an interactive web environment for hosted sites. In particular, one or more merchant sites will be in communication with an internet communication backbone to permit user access to transactional servers supporting the merchant site. A separate computer system with programmed processor implements the pricing algorithm that supports the discounted transactions. Registered users and their related demographics are stored locally or remotely (in the cloud) to support implementation of the various pricing arrangements as dictated by the programmed algorithms of the processor. Event driven operations of the system interconnect tracking and related coordination software based servers so that participating web sites—Facebook, etc.—can communicate and provide and receive appropriate data in accordance with the discount plan in use. This is generally depicted in FIG. 1.

### “Purchase as a Service”

Two business questions may be seen as having driven the evolution of Marketing-Based Discounts technology. First, how might publishers regain the free advertising that they lost with the advent of coverless eBooks: the continual, passive promotion of individual book and periodical titles by readers on airplanes, beaches, in waiting rooms, or any other community setting. Second, how might free-entry online communities generate revenue from a subscriber base or audience without suffering the attrition that comes when users and advertisers are asked to “pay to play.”

One embodiment of the YouBoard engine may be described as being “Paid to Play,” through an innovative “Purchase as a Service” (“PAAS”) model. Marketing-Based Discounts may add compensation to the back end of retail transactions to employ buyers as marketers, an activity with tangible business effects. One such effect is to permit each product, whether physical or digital, to become a uniquely defined post-sale revenue engine accruing revenues to both the original seller of the item, and consumers of the item who, according to certain MBD terms, may have agreed to become resellers or reselling agents for the good or service that they purchased. More simply, the exercise of an MBD within an MBD-covered purchase may begin a service, rather than conclude one.

Manufacturers may reduce their final sale price as a benefit to consumers in exchange for follow-on marketing, granting consumers the sole discretion to discount MBD-covered purchase prices according to the MBD options presented. In return, consumers who exercised MBDs for a specific purchase may agree via clickthrough license to the automated generation of postings about that specific purchase and their subsequent product or service usage to YouBoard for display on YouBoard.net and routing to Facebook, Twitter, Google+, and any other designated social network accounts.

MBD-covered transactions may include purchases of services, new and used goods, property, brokerage commissions, menu selections at a restaurant—any purchase transaction. Hard goods purchased using MBDs may have an electronic means of enabling post-sale MBD fulfillment, or may simply carry an individual bar code that may be scanned by a future buyer for subsequent purchase, generating an MBD sales credit and YouBoard posting for the seller. Separately, the buyer may employ their own YouBoard account preferences to facilitate the automated buying and shipping of the item, exercise of an MBD and pre-approved posting to YouBoard of their MBD-covered purchase.

For example, a prospective user may choose to visit youboard.net either via web browser, mobile browser, or some other method to set up a YouBoard account. Such prospective YouBoard User would be presented with the opportunity to sign in, or to register to become a YouBoard User. Upon electing to register, the prospective YouBoard User would be asked to provide information including email address to select a password, and may be asked to select a user name. Upon selecting a user name and password, the prospective YouBoard User may then be asked to log in, as a YouBoard User. Upon logging in, the newly registered YouBoard User may be presented with an online form or forms providing for the entry of Preferences, which may include Routing Accounts, including the social media accounts that the user may intend to utilize for future YouBoard Postings. Such account information may include accounts at Facebook, Twitter, Google+, or other social media or sharing sites, as well as e-commerce sites such as, for example, Amazon. The prospective YouBoard User may then be presented with additional choices, on the same page or a new, secure web page, to enter payment information and account information such as debit account, credit accounts, or other payment accounts including, for example, PayPal. Such information may be utilized to facilitate payment at e-commerce sites, or via YouBoard checkout or mobile payment applications, which may be developed to facilitate the YouBoard process within consumer e-commerce behavior. Additional preferences which the user may choose to fill out may include Generic or Demographic Information.

Such generic or Demographic information may be descriptive data as to age, gender, location, or any other demographic information which may be applicable to e-commerce transactions, such that generic data generated by YouBoard Purchases may be shared as non-private, indicative data characterizing the purchaser without identifying the purchaser individually or posting to social networks on behalf of the purchaser. Such Generic or demographic information may, however, be meaningful for formation of YouBoard Velocity Clouds, where the individual identity of the YouBoard Purchaser may be less important than the demographic profile and its link to product usage under other YouBoard embodiments. Such Generic or Demographic data may also be applicable to MBD programs where the individual identity of the buyer is not required to be disclosed, but where generic demographic information may nevertheless be of tangible commercial value to suppliers seeking to generate sales YouBoard Velocity Clouds, or to other YouBoard Users seeking to identify with such demographically banded communities on YouBoard as to purchases, consumption of services, or other shared activity.

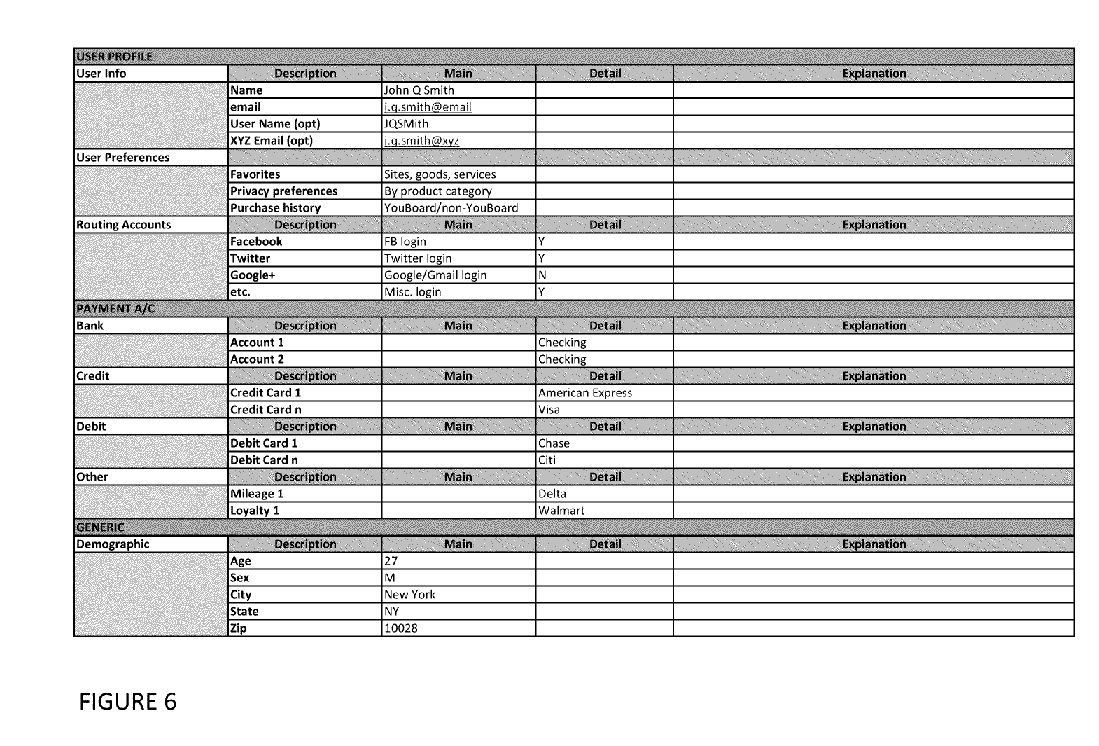

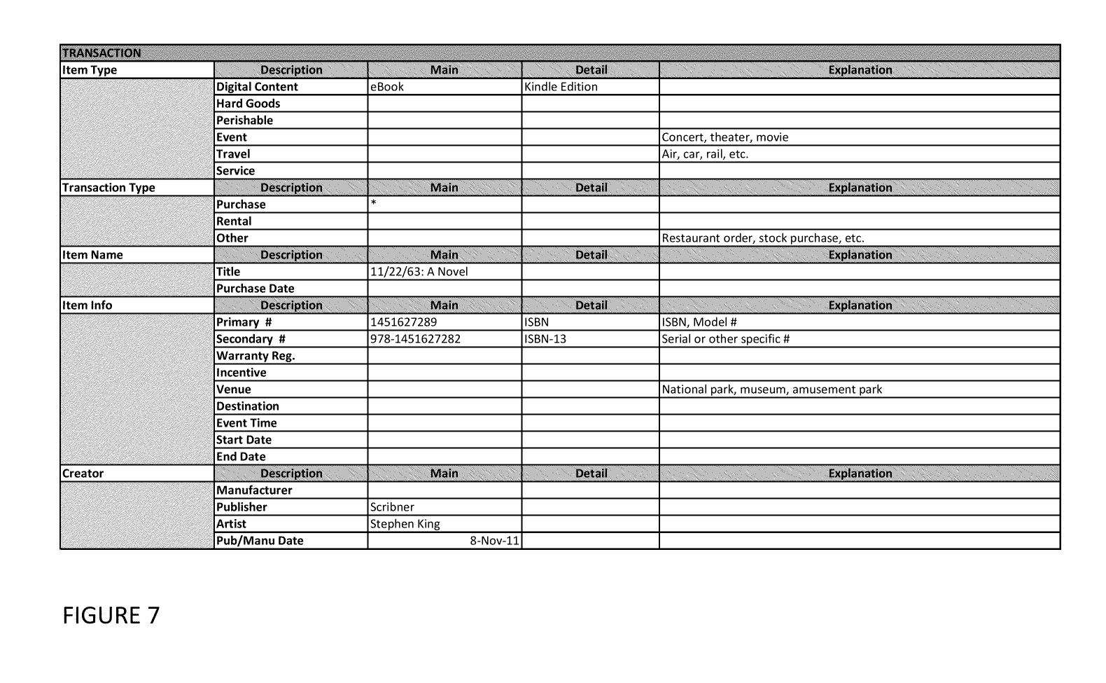

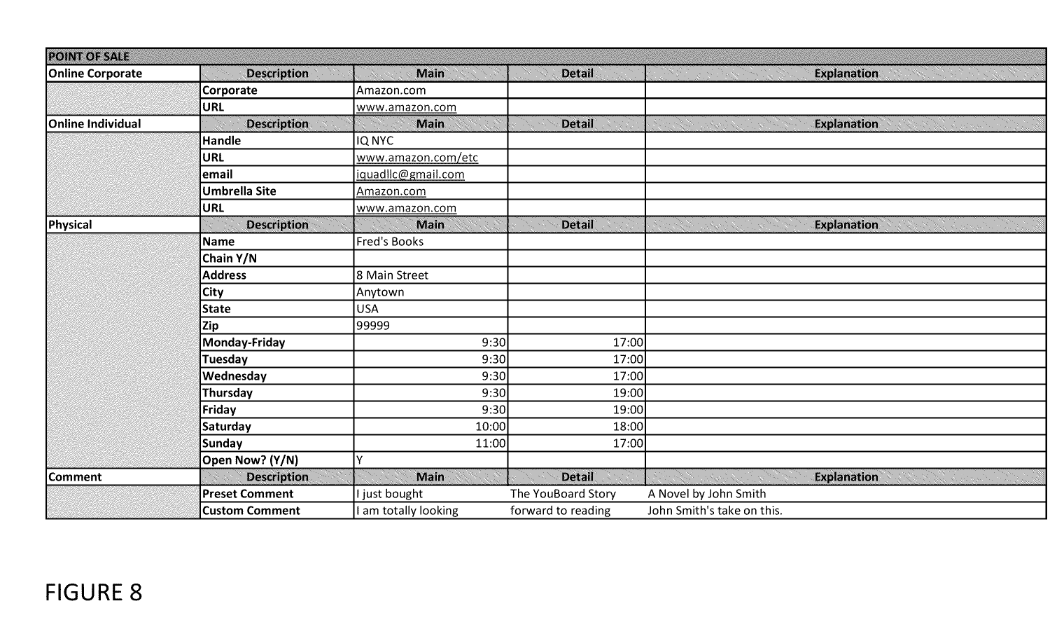

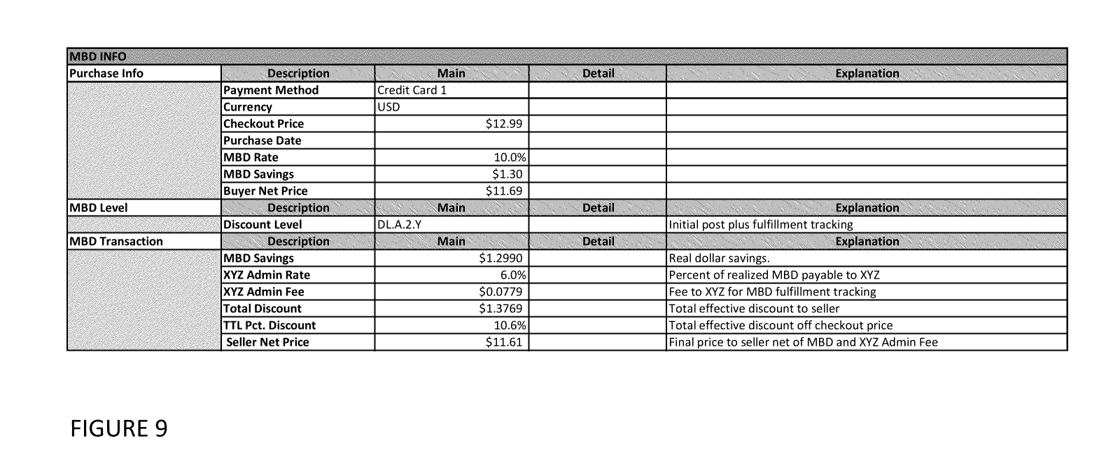

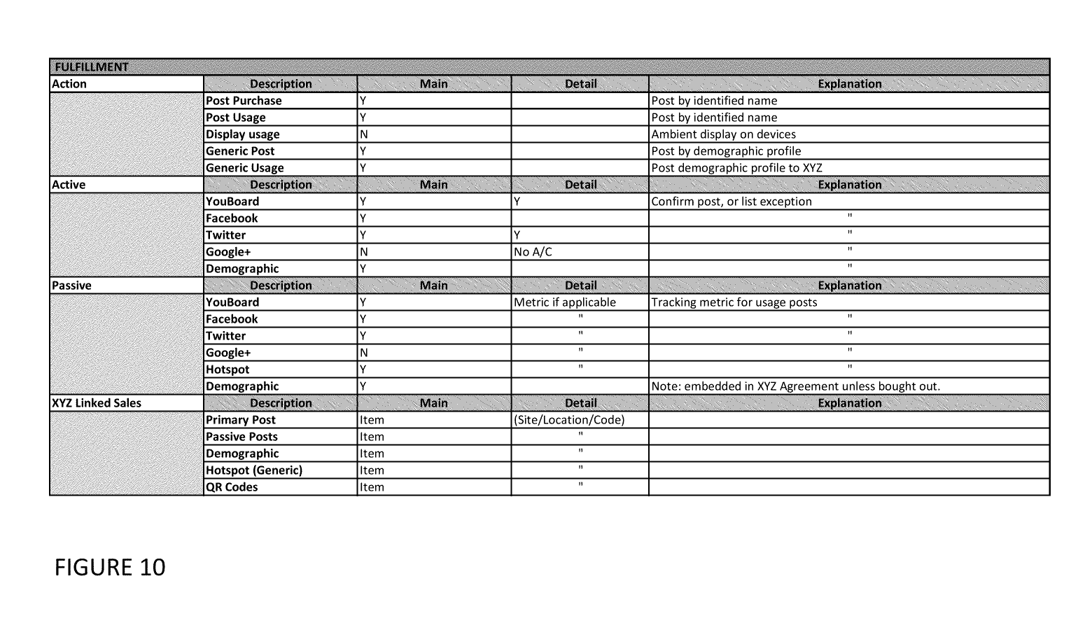

Subsequent to registration, a YouBoard User may trigger a YouBoard Purchase event, and transaction information may be recorded. Such transaction information may be stored by YouBoard to identify YouBoard User preferences as to e-commerce sites, favorite goods and services, as well as to record detailed information as to the nature of the goods or services purchased, the transaction type, whether a purchase, rental, or subscription, whether the products are digital, hard goods, or perishable items, etc. Such transaction information may also include specifics as to the item purchases, its product type, the location purchased, manner purchased, manufacturer, retailer, etc. Similar provision may permit the recording of whether a purchase was made from an e-commerce site or an individual seller, and may additionally record purchases made, via YouBoard or other mobile payment apps or simple credit card purchases, which may be downloaded from credit card statements or may be elected to be downloaded automatically pursuant to a YouBoard proprietary or other mechanism, from physical stores, and may incorporate detailed information regarding such physical stores including location, hours of operation, and other information. Through this physical store record keeping and database feature, manufacturers may offer MBDs directly for their products in local stores, or local stores may offer MBDs, and may achieve visibility through either of these offerings or some other focus that may be brought by social media activity. FIGS. 6-10 illustrate various embodiments of purchase events and/or transaction information.

The YouBoard User may also be provided with the opportunity to create static posting messages for certain types of purchases, or to be posted with subsequent YouBoard Postings pursuant to the terms of the elected MBD.

The YouBoard account will also maintain a database of such exercised MBDs, including payment methods, discounts provided, specifics as to Discount Level, and may include additional information regarding the MBD-covered transaction including specifics as to YouBoard's license feel, the net price paid to the seller, or other information.

In addition, the YouBoard account may permit ongoing adjustments to posting as well as other preferences, including the capability to identify desired influencers, and to increase or decrease the amount of information or frequency of update for particular YouBoard individuals. As a site with social networking as well as e-commerce features,

YouBoard may utilize the techniques currently used by other social networking sites to make associations between YouBoard Users comparable to the Facebook friend, the LinkedIn network, following on Twitter, or other associative tools used by other social sites. In doing so, YouBoard may provide features to manage the postings that YouBoard Users receive from other YouBoard Users or via Facebook, Twitter, or elsewhere, to enable to YouBoard User to decrease or filter the updates from particular individuals or entities, or to increase said information flows. Such YouBoard features may permit the identification of key influencers across many divergent groups or associations within the YouBoard database, including the potential for such key influencers to generate income or compensation from various avenues, including influenced sales, various product choices or customizations, or other significant data points, by explicit recording of such economically significant data as it is reported to YouBoard.

### YouBoard Events and Velocity Clouds

Once YouBoard checkout consummated an MBD-covered purchase transaction, YouBoard.net may maintain the history of realized MBDs for each user and track their MBD fulfillment, additional credits, fulfillment-linked follow-on sales, and other related information. Each purchase and subsequent MBD fulfillment post may represent a “YouBoard event.”

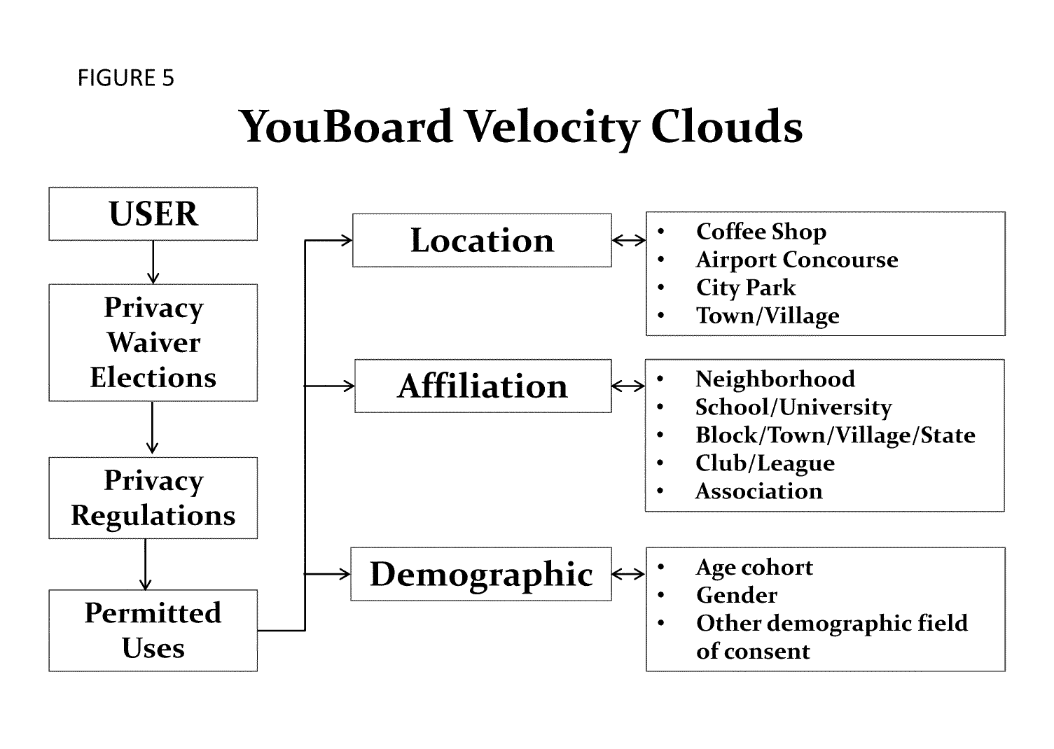

YouBoard events may be reported by YouBoard.net and aggregated as “Velocity Clouds.” Velocity Clouds may be formed by granular measurements assembled in modular building blocks for any definable community. FIG. 5 illustrates an embodiment of Velocity Cloud Formation. Velocity Clouds may be the public pulse, more vibrant than bestseller rankings because they may be real-time, post-retail, cross-product consumption lists rather than simple proprietary records of purchases.

Businesses and consumers may have the tools to easily define and search activity for custom communities based on location, demographics, or common interest, from the local hotspot to neighborhoods, membership organizations, schools or universities, entire cities. Licensed public YouBoards may show the bestselling items as well as the most-read books, most-watched videos, and other product categories in a particular venue or location, such as a Starbucks, or Yankee Stadium.

YouBoard postings on apps and web pages may present links enabling users to purchase the displayed products and services from the original vendor, steering potential customers back to the original point of sale (“POS”). One immediate benefit to merchants offering MBDs may be that consumers influenced to buy as a result of the YouBoard posting may not think, “Where can I get that product,” but may be delivered to their real or virtual door.

YouBoard's merchant interface may empower online and physical merchants to choose from a variety of MBDs, together with tools to track the utilization of MBDs, as well as the frequency and effectiveness of usage-based YouBoard advertising posts. Consumers may be able to access their YouBoard accounts and settings through customizable YouBoard home pages, through branded apps on mobile devices or integrated within social media platforms. YouBoard may provide sophisticated location-based search tools to direct them toward local retail sources where YouBoard events were occurring, and toward local merchants who were offering MBDs via YouBoard's merchant interface. Among other services, the YouBoard Merchant Interface may enable the merchant to track all discounts offered and advertisements generated, including income derived therefrom.

The ability to view or search local YouBoard events and available MBDs may be a significant benefit when integrated with YouBoard account payment capabilities and purchase preferences, drawing YouBoard users and viewers to local establishments and making MBDs effective locally as well as online.

Additional feedback benefits may be available to the Merchant via YouBoard. Whereas surveys often offer consideration as a means to encourage the customer to provide more valuable feedback, this must be offered as an additional consideration. As a discretionary incentive at the end of the consumer transaction, YouBoard be definition will offer such consideration, and thus may obtain more valuable answers to questions such as, “Why do you like this merchant?”; “Have you bought from this merchant before?”; “Would you buy from this merchant again?”; and “Would you recommend this merchant?” in this sense YouBoard is an incentive and feedback pipeline through which the merchant can build a stronger relationship with the customer, including a greater freedom to interact with the customer with respect to survey answers, since the identity of the survey subject will be known, and may not require a separate privacy waiver for subsequent contact. The most valuable referral customers may facilitate follow-on marketing via influencer based recommendations as the referral trials may be explicit and privacy managed.

### Privacy Management

YouBoard's reshaping of retail transactions may generate social data compliant in advance with “opt in” and “do not track” privacy regulations and pre-approved for use in social ad campaigns, significantly reducing the “privacy risk” embodied by regulatory uncertainty, as described in a February, Wall Street Journal story, “Facebook and Google Are Risking an Invasion of Privacy From Regulators”:

For an idea of what might befall the Internet industry if it isn't careful, look at privacy regulations being proposed in Europe. The European Commission wants to prevent companies from sharing users' information unless users explicitly allow them to. Such a rule may hamstring the online ad industry if it were rolled out in the U.S. Today, users typically have to ‘opt out’ of being tracked via online ‘cookies’ rather than ‘opt in.’

Already there have been calls for more regulation in the U.S. The FTC has called for a ‘do not track’ system to protect users' browser activity from outside snooping. The Obama administration wants a ‘Privacy Bill of Rights.’ Lawmakers introduced more than a dozen privacy bills in Congress last year. (Winkler, 2012)

Through YouBoard's privacy rights management, the adverse impact from future privacy regulation, either in reduced revenues or potential liability for misuse, may be substantially pre-empted. Via the MBD technology, each consumer may make a specific and voluntary decision to provide POS data, in exchange for real consideration. Consumers may have consented to post agreed personal data to social networks, and for its use in search and sponsored advertising, according to their YouBoard account agreement and their clickthrough acceptance of individual MBDs.

Within the MBD technology, the consumer may need to manifest assent via clickthrough license within every individual MBD-covered purchase, receiving contractual consideration for each limited privacy waiver and compensation, via the MBD, for each instance of opting-in, and thus the technology may render an explicit value for each individual privacy waiver.

Such waivers of privacy under the YouBoard agreement through positive exercise of an MBD may be specific to each transaction, and may not be irrevocable; the consumer may have the ability to buy back the specific MBD privacy waiver at any time. This is in contrast to current blanket waivers under most existing social network account agreements, which are irrevocable, even though the agreements themselves are moving targets, continually evolving at the sole discretion of the site administrator. The YouBoard account agreement may vest consumers with durable and sole discretionary control of what they want to share, and what they do not want to share (the “Fifty Shades of Grey” exception).

For example, a purchaser who has exercised Discount Level DL.A.2.n, as described below, may wish to terminate their fulfillment of the terms of the given Discount Level. In one embodiment, such YouBoard User wishing to so terminate a YouBoard Commitment may log onto their YouBoard account, and search for or access the specific YouBoard Commitment they wish to terminate. Such YouBoard Commitment may be presented as a line item on a list of YouBoard Commitments, or exercised YouBoard Discounts. The YouBoard User may then select the specific YouBoard Commitment, for example through a checkbox on the same line provided to enable such selection, and be presented with various choices of action with respect to that YouBoard Commitment. Such actions may include tracking fulfillments to date, or any accrued YouBoard credits or benefits, and may also include the option to terminate said YouBoard Commitment. Upon pressing the enter key, OK button, or taking other affirmative action, the YouBoard system may ask for confirmation, for example, “Are you sure you want to terminate this YouBoard Commitment?” The YouBoard User may be asked to click “Yes,” or “No,” depending on their choice. Upon clicking “Yes,” they may be presented with the cost of termination, which cost would be the initial discount that was provided, or some prorated component of that cost, which may be less based on the passage of time, or subsequent sales triggered, or some other metric, or may be reduced to zero as a result of accrued fulfillments. Upon agreeing to pay the fee, again through affirmative action of clicking a “Yes” button, the YouBoard termination fee may be paid, and the YouBoard Commitment terminated.

Revocable privacy waivers exist. A February, 2012 New York Times article described startups such as Personal, Locker Project, Connect.me, and Singly, which equipped customers to create online “personal data lockers” in the hope of earning money from business use of their personal information. These startups granted users the same discretionary privacy control that YouBoard may enable, but may not have delivered the manifold consumer and business incentives that YouBoard's PAAS model may offer to encourage the user to build and maintain their personal data lockers in the first place: “A challenge for [Personal.com] will be whether it can offer enough money to persuade people to use the system. Consumer information is worth billions in aggregate, but individually, the bits of data are worth practically nothing... [P]eople may find creating detailed databases about themselves too onerous to justify the potential rewards. In order to create a real market for data, enough people need to see an immediate, tangible benefit in filling up their lockers, said Mr. Green of Personal...But when he showed his audience [potential users ] how entering their data into Personal allowed them to fill out online forms with a single click, something snapped for them. “I don't think we quite realized how much of an emotional vein that tapped into,” he said, “It's not easy to make data sexy or fun. It's not sharing photos with your friends on Facebook.” (Brustein, 2012)

The MBD/YouBoard engine's persuasion may be drawn from its unique and largely unrestricted consumer incentives. YouBoard users may realize real and recurring savings on many forms of their household spending, and may receive incremental compensation for their data with each new purchase of an MBD-covered item.

Because there has been an explicit exchange of value for data, and because YouBoard may require the user to buy back the MBD in order to retire a specific posting, its privacy rights waiver may be far “stickier,” increasing YouBoard data's value to businesses, since the exchange of consideration can be expected to reduce the risk that a legitimate commercial use of YouBoard data may later be deemed inappropriate.

### Changing Privacy Economics

YouBoard's linking of consumer data income to retail spending, and to retail savings in particular, offers the prospect of more promising returns to consumers than the hope that voluntary online aggregation of personal data may draw a rain of pennies from the coffers of passing advertisers. The YouBoard model may offer a pathway for consumers to be paid up front for their data, and incrementally on a recurring basis, at their individual discretion.

YouBoard's combination of incentives and passive advertising services provides a mechanism for the incremental economic expression of the tradeoffs between business interest in exploiting consumer information, the value of information exchange, and the dichotomy between consumers' desire for privacy vs. their willingness “to put aside privacy concerns, providing personal information for even small rewards.” (Acquisti & Grossklags, 2005)“In such cases, people readily accept trade-offs between privacy and monetary benefits (Hann et al. 2007) or personalization (Chellappa and Sin 2005)”. (Tsai et al., 2010)“Responsible sharing of personal information lays a stable foundation for a productive and successful economy. It enhances customer satisfaction, generates surplus, and efficiency for the businesses and reduces fraudulent practices...Customers save about 17 billion USD and 320 million hours annually from sharing of information by financial institutions with their affiliates and third parties.” (Zhan & Rajamani, 2008)

The value consumers attribute to privacy within an individual retail transaction has been elusive, affected by context (Kahneman D. A., 1984), price changes and relative comparisons (Kahneman D. T., 1979) (Shih-Fen S Chen, 1998), and because “it is difficult to quantify the cost, benefits, and risks involved in information disclosure as most of the evaluation boils down to a subjective nature.” (Than & Rajamani, 2008) More recent research suggests that the privacy premium consumers may assign to a particular purchase is a percentage of the absolute price that decreases as the absolute price rises, ranging from 4.0 percent of the absolute price for less expensive items to an apparent cap of $20 for the purchase of a $20,000 luxury item. (Tsai et al., 2010)

These findings suggest that consumers may need to receive compensation of 4.0 percent to feel comfortable waiving privacy for a particular purchase, but also that a merchant who offered a 5.0 percent Marketing-Based Discount, receiving a privacy wavier plus post-sale YouBoard advertising in exchange, may be paying an effective cost of only 1.0 percent for the advertising services. Taking this a step further, with the value to the merchant of the privacy waiver taken into account, even a 10 percent MBD might equate to a 6.0 percent absolute discount at the time of sale. Cost amortization to break-even across various MBD programs might therefore occur much sooner for the merchant than the absolute number suggest.

Furthermore, YouBoard may be innovative in proposing explicit compensation to consumers for usage tracking, which may initiate more regular, predictable, and less restricted commercial access to and use of private data that heretofore may not have been effectively or materially incorporated into the personal data locker model, even though it may also be seen as one of the central components within Facebook's announcement, July 6, 2012, that it intended to track the apps that people purchased, potentially as a first step toward tracking what they do inside apps, as that information may be gathered by the “Facebook Connect” login feature (Raice, 2012): “Up until now, the Menlo Park, Calif., company has only pushed ads to people if they have effectively given permission to see the ad because they have ‘liked’ a brand or company on the social network. With the new mobile ads, Facebook will target certain ads without getting that permission. Privacy advocates said Facebook should provide ways for users to opt out of the mobile ad targeting. Justin Brookman, director of the Center for Democracy and Technology's project on consumer privacy, said Facebook would ideally allow people to log in via Facebook Connect and then not track what they do. But ‘if they are going to do it, they should be transparent about it,’ Mr. Brookman said. ‘Once you're signed in, are you really expecting that Facebook is going to be watching you while you're on there?’ (Raice, 2012)

The MBD/YouBoard model creates a mechanism to establish a real economic value for the secondary brand advertising that consumers have offered through product usage for years, as well as establishing a real, quantifiable and auditable process to generate real compensation to consumers for that value. By enlisting consumers as compensated participants in a holistic, multi-stage marketing process, and through explicit recognition of consumers' value, role, and function as secondary advertisers, YouBoard may permit a material shift in the perception and discussion of online consumer privacy, from its current focus on deconstructing privacy policies to see what companies may have appropriated from consumers, and to identify what retroactive privacy rights a consumer may have sacrificed for no compensation and in perpetuity, to different discussion centered on a constructive economic model that in addition to creating savings for consumers and establishing compensation flows to consumers for future services, may also position the online advertising industry itself for accelerated growth. In this example, such growth would be supported by an expansion that may be significant in magnitude, of the online behavioral data on which such advertising is substantively based. Such advertising is constrained by consumer privacy concerns, both the intrinsic reluctance to share information and an equally significant and separate reluctance to share information for no compensation, as well as concerns by corporations and other entities over the economic impact of future privacy regulations, both as they may increase the cost of data acquisition, as well as the risk of potential liabilities and damages for findings of violations by regulatory bodies. With the rise of reliable and predictable incremental compensation to consumers for the disclosure of their personal information, privacy concerns for the data generated by such transactions will be significantly eased by contractual terms, and the database of such data may presumably be expanded, reducing regulatory and policy constraints on, and increasing the information assets available to, the online advertising industry.

In YouBoard's case, this economic proposition with respect to consumer privacy may prove robust because much of it will be based on merchandise that may already have been sold. The merchant may have realized revenue, the consumer may have realized actual monetary savings, and the subsequent online advertising will be substantively directed away from the individual YouBoard user, toward their spheres of influence and the larger social media universe where YouBoard Postings are viewed.

The YouBoard model is notably different than the models that were employed by Blippy, a failed purchase sharing site, and the model initially employed by Swipely, a cash back and rewards aggregation site that also shared purchase information. Blippy launched in 2010 as a purchase sharing site with postings that headlined the total amount spent in a charge transaction in bold numbers, placing the focus on expenditures that even people eager to share details regarding their product purchases would arguably prefer to keep private, and a detail, the total transaction cost, that may be perceived as the least significant piece of information generated, being of little interest to other consumers and of arguably no value to businesses seeking to use such information to profile or sell to the buyer. Buyers had to choose a particular payment method just to send a purchase to Blippy, with no discretion to post only some of what they'd bought, and they received no consideration for the permanent wavier of privacy rights regarding that purchase which they would have retained simply by not using Blippy. The privacy component of online retail transactions is estimated to be approximately 4.0% of the purchase price (Tsai et al., 2010). Against this framework, Blippy presented an added incremental cost every time it was used. With no clear benefits, an embedded disincentive, and a primary focus on data that was unimportant and largely unusable, Blippy was positioned to fail.

By comparison, Swipely launched as a purchase sharing site in 2010, but then pivoted to become a credit-card based loyalty program for small businesses. Swipely did not feature the purchase price, and permitted users to decide specific items to post and what items not to post, but continued to prioritize social sharing above direct price discounting. As a result its cost/benefit utility to users varied from one transaction to the next, though this did not prevent it from evolving to become a local marketing site using conventional, point of sale incentives.

While local incentives and loyalty programs are a subset of YouBoard's projected functions, YouBoard may also provide for recurring post-sale advertising based on product usage, and may create a specific, revocable privacy waiver agreement for every covered item, so that the consumer may retain the option to buy back the privacy waiver (on a full or pro-rated basis) at a future date and terminate their post-purchase fulfillment obligations.

A key difference may be YouBoard's consistent focus on lowering the final price to consumers for products that they already want to purchase, in order to generate a reliable stream of privacy-waived social information and long-term, recurring advertising that is regularly transmitted via to social networks and among spheres of influence, furnishing a direct route back to the original point of sale for influenced purchases, with account management tools that may facilitate such influenced buyers in making automated, instant-gratification, impulse purchases.

### Self-Monetized Social Data

In one embodiment, the MBD/YouBoard engine may also offer an empirical method to determine the economic value of social media data. Social media sites, of which Facebook is the most notable, have amassed trillions of bits of information without paying direct compensation to consumers. According to the Wall Street Journal, the value of that information was implied to be $68 billion prior to the Facebook IPO, suggesting that each of its 2.1 trillion data bits was worth $0.03. Much of this data was in the form of “Likes,” freely offered opinions about mostly free information content. The arc of the Facebook IPO subsequently suggested that assigning that valuation was far from an exact science, though the market continues to see tens of billions of dollars of value in Facebook's data. What is lacking, arguably still, is an objective formula to determine that value.

Similarly, many question whether simple aggregation of private data through the “personal data locker” may present real economic value to businesses: “One problem seen with this concept is that companies are not seen as needing to pay for the information when they get it free. ‘The killer app isn't here yet,’ said William Hoffman, who is working on a multiyear study of the economics of personal data for the World Economic Forum. But with increased consumer awareness of the value of that information—Facebook could be worth as much as $100 billion—that may soon change. ‘I'm willing to bet that within the next 12 months something big will catch on,’ he said.” (Brustein, 2012)

YouBoard suggests an answer through its intrinsic real compensation, and with its model of embedded incentives and real-compensation, it is positioned to be that killer app. While it may be seen as creating an initial stage that may be perceived as creating sales friction, it may also be seen as a sales lubricant, in the sense that it may be seen as smoothing some of the rough spots that currently slow the Internet engine, which may include the speed with which purchases are shared among influence networks, as well as the speed with which data provided through a YB purchase may be exploited within permitted YB uses.

Sellers may be expected to offer MBDs because of the payoff in immediate sales and subsequent advertising, and as YouBoard became more widespread, the ability to draw in an ever larger pool of consumers. Consumers may be incented to create personal data lockers on YouBoard in order to enable the MBD fulfillment that may qualify them to realize the MBD benefits in the first place.

Realized MBDs may have empirical economic value because they may reflect real economic votes made in exchange for real consideration, directly applicable to actual goods purchased, and generating compensated demographic data unencumbered by privacy restrictions. In exchange for administering this data, YouBoard may receive a license fee of, for example, 6 percent of the realized MBD, above any transaction fee or in lieu of some portion of a transaction fee.

### EXAMPLE

The buyer of $10 eBook elects to take advantage of an offered MBD of 10 percent, or $1.00, lowering their final price for the eBook to $9.00. Under the eBook agency model, the publisher and the retailer may bear 70 percent and 30 percent of the opportunity cost of the MBD, or $0.70 and $0.30 respectively, but may receive a service from the consumer, who may agree to post information regarding the retail purchase, free of privacy restrictions. The value of this service may be represented by the license fee paid to YouBoard for managing the data, equivalent to 0.06 percent of the retail price. The data post reaches YouBoard.net accompanied by $0.06 of real revenue. (Table 1 and Table 2)

TABLE 1

| | Discount | Discount | Discount | Discount |
|---|---|---|---|---|
| | Level A | Level B | Level C | Level D |
| Transaction Price | 10.00 | 10.00 | 10.00 | 10.00 |
| MBD Rate | 5.0% | 6.0% | 7.5% | 10.0% |
| Realized MBD | $0.50 | $0.60 | $0.75 | $1.00 |
| Net Price | $9.50 | $9.40 | $9.75 | $9.00 |
| MBD License Rate | 5.0% | 6.0% | 6.0% | 5.0% |
| License Fee Per | $0.03 | $0.04 | $0.05 | $0.06 |
| Transaction | | | | |
| As Percent of Gross | 0.30% | 0.36% | 0.45% | 0.60% |
| Price | | | | |
| Total Effective Discount | 5.3% | 6.4% | 8.0% | 10.6% |
| Realized Sale Price | $9.47 | $9.36 | $9.21 | $8.94 |

TABLE 2

| | Price A | Price B | Price C | Price D |
|---|---|---|---|---|
| Transaction Price | 5.00 | 10.00 | 20.00 | 50.00 |
| MBD Rate | 10.0% | 10.0% | 10.0% | 10.0% |
| Realized MBD | $0.50 | $1.00 | $2.00 | $5.00 |
| Net Price | $4.50 | $9.00 | $18.00 | $45.00 |
| MBD License Rate | 6.0% | 5.0% | 6.0% | 5.0% |
| License Fee Per Transaction | $0.03 | $0.06 | $0.12 | $0.30 |
| As Percent of Gross Price | 0.60% | 0.60% | 0.50% | 0.50% |
| Total Effective Discount | 10.6% | 10.6% | 10.5% | 10.5% |
| Realized Sale Price | $4.47 | $8.94 | $17.88 | $44.70 |

In exchange for offering the MBD and paying YouBoard the MBD license fee, the publisher of the eBook may realize two benefits. The purchase may post to YouBoard as a socially focused advertisement, and the consumer may have agreed to advertise, or post, their reading of the book essentially in perpetuity. If each Like could be appraised at $0.03, then Point of Sale (“POS”) data that arrives with an embedded license fee and a buyer commitment to ongoing social advertising should be worth more, because it may represent choices that were recurring, self-renewing, and evergreen.

There were 59.5 billion credit and debit card transactions in the US in 2010, for a cumulative total of $3.29 trillion (Table 3, excluding over $32 trillion in check transactions). Projecting MBD market penetration at 5.0 percent of this dollar amount (Table 4), using an average MBD rate of 5.0 percent with an MBD license rate of 6.0 percent, may have yielded realized MBD savings worth $8.2 billion to consumers, while generating MBD license fees alone of $495 million. Applying MBDs to 10.0 percent of card transactions, at an average MBD rate of 7.5 percent and a license rate of 6.0 percent, may have yielded realized MBD savings to consumers of $24.7 billion, generating $1.48 billion in MBD license fees.

The realized MBDs may be the total compensation that may be paid to consumers for agreeing to post purchase and use information to YouBoard, and these two relatively conservative scenarios suggest the incentive may be significant.

TABLE 3

| | Total | Average | Total |
|---|---|---|---|
| | Transactions | Transaction | Value |
| Total Noncash Payments 2010* | (billion) | Size | (trillion $) |
| Debit Card Transactions | 37.9 | $38.00 | $1,440 |
| (billion) | | | |
| Credit Card Transections | 21.6 | $85 00 | $1,858 |
| (billion) | | | |
| Total Credit + Debit | 59.5 | | $3,298 |

TABLE 4

| | MBD Marker Penetration | | | |
|---|---|---|---|---|
| | Conservative | Moderate (Low) | Moderate (High) | Aggressive |
| | 5.0% | 10.0% | 20.0% | 33.0% |
| Total Distinct MBD Posts (billion) | 3.0 | 6.0 | 11.9 | 19.6 |
| Total MBD Transactions (billion $) | $165 | $330 | $660 | $1,088 |
| Average MBD Rate | 5.0% | | | |
| Realized Consumer Savings (million $) | $8,245 | $16,489 | $32,978 | $54,414 |
| MBD License Fees (@ rate, million $): | | | | |
| 5.0% | $412 | $824 | $1,649 | $2,721 |
| 6.0% | $495 | $989 | $1,373 | $3,265 |
| 10.0% | $824 | $1,649 | $3,298 | $5,441 |
| Average MBD Rate | 7.5% | | | |
| Realized Consumer Savings (million $) | $12,367 | $24,734 | $49,467 | $81,521 |
| MBD License Fees (@ rate, million $): | | | | |
| 5.0% | $618 | $1,237 | $2,473 | $4,081 |
| 6.0% | $742 | $1,484 | $2,958 | $4,397 |
| 10.0% | $1,237 | $2,473 | $4,947 | $8,162 |
| Average MBD Rate | 10.0% | | | |
| Realized Consumer Savings (million $) | $16,489 | $32,978 | $65,955 | $108,827 |
| MBD License Fees (@ rate, million $): | | | | |
| 5.0% | $824 | $1,549 | $3,298 | $5,441 |
| 6.0% | $989 | $1,979 | $3,957 | $6,530 |
| 10.0% | $1,643 | $3,298 | $6,596 | $10,383 |

### Tangible Benefits to Merchant and Consumer

Material savings realized through the PAAS mechanism may bring an important new dimension to retail transactions. YouBoard may be seen as generating earnings by helping consumers save money, a result of economic efficiency made possible by leveraging modern technology.

Under the MBD transaction technology, final discretionary control over price and privacy may be vested in the consumer. Buyers may be empowered to lower their end price for MBD-covered purchases. Publishers and retailers may garner real consideration from consumers who may realize tangible savings in exchange for their passive marketing to other consumers. These potentialities signal that the economics of MBDs may differ from those of conventional incentives in important ways, with significant positive implications.

Current coupons apply to a single purchase by the consumer, with follow-up limited to membership discounts, loyalty points, and warranty service. Under the MBD model, each purchase may become a unit acquired plus a service compensated. In the previous eBook example, the publisher received advertising services equal to and more durable than typical click-through advertising, and more specifically targeted within social spheres of influence, while the consumer was directly compensated in real savings for data they might now give away, and for restoring services provided for free in an analog world (such as secondary advertising through a book cover).

Unlike existing incentives, which are a fixed cost of goods sold, MBDs may be self-amortizing service agreements that are most expensive at the time of sale. Each subsequent MBD-linked posting may come at no incremental cost to the MBD provider, averaging down the cost of each posting throughout the duration of the MBD fulfillment. This open-ended passive advertising commitment may be a form of residual benefit to merchants, who otherwise may need to pay for the advertisements. Where a consumer chose to buy back the MBD commitment, the MBD-related purchase and usage postings may have come at essentially no cost to the merchant. In fact, economic studies suggest that MBD's may be a fair exchange for the merchant almost immediately.

From the consumer's perspective, realized MBDs may constitute real savings, rather than illusory savings, because for each transaction where an MBD was realized, a higher price may exist were the MBD not chosen. Purchasers who logged onto YouBoard to buy back a specific MBD and rescind their original permission may be returning their consideration in exchange for cancelling their fulfillment obligations, evidence of the persistent value embodied within each MBD.

Polls can be conducted 365 days a year, but only the results of the election count. Distinctively, YouBoard events may reflect the economic elections of individual consumers, not just their preferences. This is not Sponsored Social Media, or “SMS,” a paid micro-advertising model grafted onto voluntary social media, where consumers are compensated for liking something, but aren't required to invest in their choice. By comparison, MBDs may be seen as requiring a down-payment, and thus pre-qualified as genuine choices.

Links to hard sales, real value, and real use may be the fundamental economic support for the MBD technology, and may enable it to generate consumer-compensated “social economic” data reflecting real purchase decisions by potentially hundreds of millions of consumers, all discoverable and searchable on YouBoard, while delivering effective marketing tools at efficient cost to merchants and thereby substantially raising the economic productivity of consumer incentive programs.

### Mobile Monetization

The MBD technology may be applied to any electronically recorded retail sale, including purchases made at physical retail establishments, making every retail purchase transaction unique, and suggesting a substantial opportunity for widespread consumer adoption of the MBD purchase model through the use of mobile payment methods.

Mobile apps and devices are expected to become the dominant methods of payment in a future cashless society, a reasonable expectation given that there were 4.0 billion distinct mobile users at the end of 2011, 57 percent of the world's population. (Ahonen, 2012) “Done right, mobile payments can accelerate the monetary exchange, while streamlining the issuance, acceptance and storage of receipts, coupons and loyalty cards. Down the road—once consumer and retail use reaches critical mass—the hope is that people may be able to leave their wallets at home altogether. But there's a chicken and egg paradox: Customers won't start using mobile payments in great numbers until they're accepted in great numbers, and retailers don't have a huge incentive to roll these systems out until customers are clamoring to pay this way.” (Temple, 2012)

The 24/7/365 consumer-discretionary savings made possible through MBDs may build an intrinsic incentive into every MBD-covered transaction, and may be a powerful inducement for consumers to join and use YouBoard, and to push for YouBoard's model to extend to in-store purchases, where the optimal presentation of YouBoard's clickthrough interface may be through mobile payment apps.

By offering a discount at the final stage of every MBD-covered transaction, YouBoard may be in a position to offer the lowest price for MBD-covered goods available anywhere, arming licensed platforms with a powerful advantage to become the preferred method for mobile retail purchases.

As a mobile monetization strategy with embedded incentives tied to a central element of individual economic behavior, the MBD/YouBoard engine may see levels of user engagement high enough to drive widespread consumer adoption of mobile payments. Through this differentiation the technology may potentially affect who emerges as the mobile payments winner among PayPal, Visa, MasterCard, Firethorn Pay, Dwolla, Clover, Square, Google Wallet, Passbook, and many others.

Through the “be paid to play” dynamic of the PAAS (Purchase as a Service) model, Marketing-Based Discounts and YouBoard may offer innovative scenarios for growth in e-commerce and local retail. In contrast to the non-compensatory model practiced by Facebook, YouBoard may leverage the economic exploitation of social media data to deliver tangible benefits to consumers, including the innovative presentation of technology-enabled incentive pricing within every MBD-covered purchase.

In one embodiment, a purchaser who may be contemplating the purchase of an MBD-covered item may have the ability to choose from various payment methods, including but not limited to, cash, a credit card or debit card interface, a mobile payment app such as Google Wallet, or YouBoard, which may be available as a payment method through a YouBoard mobile payment app. In this embodiment, a user may be able to consummate the purchase transaction through all available methods, but may not be able to receive the MBD without using YouBoard, nor be able to offer the future advertising and promotional services, through the other payment methods, that provide the value to the seller in consideration for offering the MBD in the first place. Among this group of payment methods, YouBoard may thus be seen as novel in being the only method permitting the purchaser to offer services in exchange for an immediate discount from the purchase price.

Notably, in this example, and other examples of YouBoard checkout, the decision to share certain data and to waive privacy for a particular item may be embedded in the process of electing the MBD, and thus may be concluded prior to the final sale of the item via consummation of the checkout process. This may be contrasted with the current process whereby a consumer purchasing an item on Amazon, for example, is asked, after the purchase has been completed, to share on Facebook or Twitter or Pinterest or other sites, again for no compensation beyond what is, for lack of a better description, “Sharing!” The YouBoard model reverses those steps, placing the sharing act before the final payment, while offering a real economic incentive to the purchaser for exercising the MBD, rather than asking a buyer who has just consummated a transaction to share a purchase, because, ultimately, Facebook wants the information for free, and by presenting the opportunity in the context of there being intrinsic value in sharing certain information with a buyer's Facebook friends, obtains valuable data from the buyer at no cost where the buyer elects to do so. In comparing the two examples, with respect to the social sharing template, it may be seen that the number of steps are the same: in the YouBoard example, exchanging value by exercising the MBD and committing to share, and then paying the purchase price; in the Facebook example, paying the purchase price, and then committing to share without an exchange of value. Two steps occur in each sharing example. In the first, YouBoard provides benefits to the consumer for sharing, and in exchange extracts a commitment to share again in the future. In the second, Facebook simply provides an avenue for a single update, with no future commitment and no economic benefit. Notably, in addition to creating a series of future economic potentialities including potential credited sales, the YouBoard example where an MBD is exercised results in at least one current Facebook posting and possibly multiple future Facebook postings, where the purchaser has a Facebook account and elects to post to it, which may be seen as a prerequisite to be compared with a transaction where a user elects to use the post-purchase Facebook share button. The Facebook example results in a single current post, with future effects being more advertising aimed at the purchaser by Facebook, and potentially credited future sales for which no current mechanism provides economic compensation.

Through this example it may be seen that the MBD/YouBoard engine may deliver tangible economic incentives to all participants of a retail transaction, from checkout through purchase postings through the new machinery of PAAS and automated consumer-to-consumer social advertising. Sellers gain value from post-sale promotion, while buyers gain value from real discretionary savings, credits for influenced sales, and from YouBoard's social network where they can view postings from their friends, track their own purchases and realized MBDs, and benefit from targeted MBDs specifically tailored to their interests.

Economic research suggests that MBDs between 5.0 to 10.0 percent may be fair and productive for both merchants and consumers. YouBoard's combination of bilateral incentives, social marketing, and efficient privacy management may make the retail transaction even more of a social act, drawing on potentially billions of retail shoppers and leveraging POS data to generate real-time, self-monetizing social media content that may build and sustain the value of YouBoard's Velocity Clouds as metrics of consumer retail activity, and product usage by online and local communities.

Embedded incentives and retail price competitiveness may reasonably make YouBoard attractive to a growing population of consumers who may be specifically targeted by an expanding group of physical as well as and online retailers. The unique economic underpinning of MBDs may similarly facilitate the consumer adoption of mobile payment methods by positioning mobile payment apps as a means toward obtaining the most competitive retail price, making mobile devices direct touch-point platforms operating at millions of physical points-of-sale for the monetization of evolving web and mobile products and services.

### Embodiments

In one embodiment YB Data is generated and displayed on a licensed “YB Data Display” in a public location such as an airport, railroad station, medical waiting room, or other public gathering place. As previously disclosed, such YB Data may include MBD Data and LBS Data. LBS Data may include temporary access or use of digital content including periodical content, eBooks, video and audio, and any other form of digital content.

In one embodiment an LBS may grant a user access to digital content within a defined physical location or “LBS Zone.” An LBS Zone may be defined in any appropriate technical manner including through use of the Global Positioning System (GPS) data.

In one embodiment the LBS may grants a user a portion of the total content of a periodical or book, in the same manner as portions of an eBook may be made available online prior to purchase, but not all portions, and the portions that are available may be fixed to exclude certain portions of the content, or may be randomly determined but in such a way as to prevent any user from pirating the digital content, defined as saving digital intellectual property that is protected by patent or copyright or confidentiality (“IP Content”) for unauthorized subsequent use or redistribution, or by saving such IP Protected Content made available for a fee at no charge for subsequent unauthorized use or redistribution.

In another embodiment an LBS may grant a user temporary access to the entire body of a specific digital content for the duration of the LBS. Such access may be set to expire upon the occurrence of a “Terminating Function,” an act that causes the LBS to temporarily or permanently expire. Such Terminating Function may be departure from the LBS Zone, the expiration of the time period of the LBS, or any violation of the terms of the LBS, including any attempt to pirate IP Data.

In one embodiment a user may depart an LBS Zone at an airport by boarding their flight. Such LBS Zone departure may trigger a prompt to buy the IP Content prior to the airplane's departure. In another embodiment the LBS may continue for some portion or all of the flight to be followed by a prompt to purchase the IP Content. In another embodiment the prompt to purchase the IP Content may occur at the conclusion of the flight. Any such timing or GPS based termination of the LBS may be used to trigger the digital content purchase prompt. Data regarding LBS use or LBS-generated purchase may be provided to YouBoard. Such LBS-generated purchase may be an MBD-covered purchase.

YouBoard may perform its aggregation, database, search, reporting, display and other functions in the most efficient forms including but not limited to as a website, software-as-service, a cloud data repository, a mobile information service providing real-time updates, push alerts, and other informative functions, or as an app within other computer platforms such as, for example, Facebook, Apple's App Store, Google's Android App Store, or any other means by which computer functions are distributed or accessible via the Internet and pother global networks.

YouBoard data may be accessed according to any desired geographic or demographic breakdown. For example, a user may wish to see what may be the book most being read in the airport at the moment, and further may look to see what book may be being read most by 20-30 year olds or other age group.

In another embodiment a hotspot such as a coffee shop, bookstore, or airport may display a YouBoard screen listing the top ten books, magazines, or products being purchased. Such screens may be licensed from YouBoard.

YouBoard may be compensated by a licensing fee equal to, for example, 6 percent of realized MBDs. where an $11 item was discounted to $10 as a result of a purchaser choosing to accept the MBD, then YouBoard would receive $0.06 for that transaction.

Various interfaces may be integrated with YouBoard and other advertising and retail display technologies to provide many convenient retail options for the purchase or rental of digital content including IP Content.

In one embodiment a YouBoard display may provide an interface for purchase of any available physical or digital item cited in YB Data subject to restrictions on availability as determined by the manufacturer or originator of such item.

In one embodiment the YouBoard interface is a wall-mounted display similar to a regular billboard, but variable as a graphic or tabular display. In another embodiment the YouBoard display may be presented on a larger format than a single display screen, in a form more comparable to the display shelves of a retail establishment that may sell hard goods or published words, such as a clothing store or newsstand. Such retail displays provide larger areas to present information with an efficiency which may not be matched by displays even of the same amount of items on a display screen. For example, the wall of books in a retail store permits physical browsing not just by page but also by height, and permits more objects to be displayed with more variety in thematically linked areas.

Such retail presentation is an advantageous evolution of human consumer behavior which has evolved for the most efficient presentation of goods for sale, and the purchase therefor. It may be possible to take in far more information looking at a wall of retail products than looking at a web page crowded with retail products. Retail stores have also profited from placing demonstration models on the sales floor and then providing a brand new, in the box product to a consumer who has sampled such floor model.

However, as a result of the conversion of information assets to digital formats, it may no longer be preferable to stock physical inventory. As well, Internet retailers such as Amazon have profited from the convenience of making a digital product selection with confidence that it may be delivered direct to a purchaser's home office in a timely manner. Internet retailers compensate for the ability to view numerous objects at once by making it possible to search through millions of objects, to purchase the item from the most efficient supplier, and to arrange for shipping of the item in the most expeditious manner.

In various embodiments, the MBD/YouBoard model permits an effective hybrid of the advantages of the digital and the physical store, where online goes “bricks and mortar.”

In one embodiment, display shelves may become electronic display walls, composed of a single large display or an array of smaller displays composed of screens of various sizes. Where in a regular bookstore or newsstand there may be shelves of various physical titles, electronic display walls may display book covers and news front pages in substantially the same size as the traditional retail presentation. In this manner it may be possible to brose among ten different newspapers by reviewing the headline, rather than attempting to page through a number of web pages or smaller mobile displays to find similarly interesting content. In this way a reader may scan the covers of a number of books, as well as the covers of a number of magazines or newspapers, and may sample or purchase the displayed items. One positive effect t of such ability to display a number of newspapers or magazines side by side in a more traditional manner may be to reduce the “grazing” activity of web surfing, where only portions of many, many articles are read, because the need to go through many different alternative news sources requires frequent in order to browse the same number of alternatives as a single newsstand display might present.

In one embodiment each display may provide an audio feed to go with the visual feed, which may be accessed through typing a code, or tapping a device or other interface method such as a credit card or dedicated “YouBoard Store” interface device. Each or all devices, credit cards or other interface methods, or dedicated interface device, may have a memory and may have security encryption and may communicate wirelessly with the Internet or via secure Internet or dedicated channel with merchant and financial institutions for browsing purposes as well as for payment purposes.

In one embodiment a bookstore may have one wall devoted to the top nonfiction books, another devoted to fiction, still another devoted to magazines, and another devoted to newspapers. Customers who wished to buy any of the products may purchase them through any number of methods, including but not limited to scanning a bar code displayed for each item, touching a mobile device to the screen to load the item, or acquiring the item number via barcode, Bluetooth, or physical “tap” contact, and then present this list at the time of checkout. In one embodiment checkout may occur upon leaving the physical retail location, and a prompt may be displayed on a device screen listing the items that have been reviewed and prompting the user to confirm that a purchase was intended.

In one embodiment retail display walls may be hosted at a remote site and delivered to numerous retail locations. In one embodiment these displays may be altered according to the time of day, so that a different section of digital items may be presented in the morning than are presented in the afternoon or evening. In one embodiment such retail display walls may replace simple advertising posters.

In another embodiment the display may recognize the particular individual and tailor the display of words or items or other content to the known preferences of the particular consumer.

In another embodiment the YouBoard display may show the most popular products and permit a direct interface to purchase any of these displayed products. In this embodiment YouBoard may be seen as helping to remove the obstacles to impulse buying, by supplying a context of popularity that may not extend beyond the local environment, but which may equally be most effective within such local environments, as these are defined or are formed spontaneously via YouBoard. Seeing the product locally consumed, prospective buyers may decide they want to “have it here, have it now.”

Additional benefits that may accrue from the spontaneous formation of such registered user groups and product forums may be the advent of “wikivolve,” crowd-sourced suggestions for product enhancements, complaints about product drawbacks, or suggestions for solutions drawn directly from registered users of specific products, or “contraqt,” warranty provision and sharing about warranty results, or any other form of follow on service contract, including potentially a “Q” recognition metric, that forms between consumers the sellers of products or providers of warranty services.

In one embodiment advertisements may be remotely hosted and presented as a visual display on a screen, where the same purchase interfaces may be made available. In one embodiment the advertiser may host their advertisements in a manner similar to the retail display wall, and permit consumers to purchase items directly from the advertisement by tapping or other agreed purchase methods.

In these embodiments the purchase(s) may be linked to the establishment, and the newsstand vendor may receive a royalty payment for those products the vendor may have sold.

In one embodiment periodical items may be made available at a lower cost with a fixed time limit during which the content may be available to be perused. At the conclusion of this time period the content may expire and be deleted from the device, or prompt the user for a “permanence “purchase. In this embodiment the user would not be obtaining a subscription to a periodical or app version of a periodical, but rather the single use of the periodical publication in that location or for a limited duration, as one might buy a newspaper, without automatically subscribing to have the next edition delivered at a paid subscription price.

In one embodiment the local newsstand may provide location based access to certain publications at rates determined by the period the item was used.

Publishers or other sponsors may provide no-cost internet access to permit the local purchase of their products, without requiring the purchase of a hotspot Internet account.

In one embodiment displays of such electronic retail walls may be derived from the local Velocity Cloud as reported by YouBoard and as disclosed in provisional application 61/619,105 filed Apr. 2, 2012, which is incorporated by reference in its entirety, such that a user may be presented with bestsellers particular to that location and time.

In one embodiment the merchant or the vendor or other sales agent may be providing MBDs, and may also provide the consumer with the ability to purchase insurance for the specific item at the time of purchase. Such insurance may be separate from any warranties or additional merchant warranties, and may use information that may be accessible to YouBoard as well as confidential financial information that would be required to fulfill insurance requirements for receipt and proof of payment and purchase, including location, price, time of purchase, and any other necessary data. One benefit of such a service that consumers may generate a single site for repository of their receipts and may benefit from immediate population of such receipts within their database of insurance coverage, which receipts may be considered as immediately verified by seller, manufacturer, sales agent, insurance company or other warranty entity, and may be considered the official receipt by the consumer.

Such a purchase database may be accessed by the consumer for purposes other than insurance coverage, including, for example, substantiation for tax filings, including but not limited to categorization of goods and services purchased.

For this benefit to accrue to consumers it may be necessary to create substantial security and encryption barriers between the data tiers accessible to YouBoard and the datasets that are accessible to insurance companies and financial institutions. Under the MBD technology, the consumer may decline all offered discounts and services, and any other itemized benefits, and such data would not be accessible to YouBoard or any other datasets contemplated within this specification.

In one embodiment consumers may have the option to take advantage of MBDs, to decline MBDs, and may also have the capability to pay the actual recorded dollar equivalent of the realized MBD to withdraw the data that was provided to YouBoard and other datasets from such datasets, and such rights of the consumer may be perpetual and permanent and not expire, and may be at the consumer's sole discretion.

YB Data may be generated by any economic transaction, including, for example, placing an order at a restaurant form a menu, where a bar code for the item may be placed next to the item on the menu so that a diner may scan it and post what they are eating for dinner. It may also be possible to place such orders digitally and directly within an establishment.

In one embodiment, YouBoard's Velocity Clouds may also post the name s of stores so that customers who are seeking a certain physical item that is selling well may identify the local business where it is being sold and make a direct electronic purchase. This is made most effective for local business which may have an interface for an electronic wholesaler who may provide fulfillment for the retail transactions at YouBoard Stores and any other merchant.

YouBoard may also be an effective means to interface with local businesses. In addition to individual businesses posting YouBoards showing the most popular items being sold in their store, or in their restaurant, YouBoard may also show the items being reviewed for purchase by shoppers. Such additional levels of social data may be facilitated by the YouBoard platform, such that YouBoard may duplicate non-retail functions of social networks while adding the retail dimension as described via MBDs and LBS.

Purchased products may be permitted to have variable commercial identities based on choices made by the purchaser. In one embodiment, the purchaser may be entitled and enabled via YouBoard to take advantage of certain discounts at the time of purchase, at their discretion, by choosing to meet certain criteria. The YB Price for an e-book or music file may thus be beneficially discounted at a series of levels meeting different criteria, and each discount level may have tiers within it, depending on the form by which the discount is implemented, as described in as described in U.S. Provisional Application No. 61/619,105 filed Apr. 2, 2012, which is incorporated by reference in its entirety.

Such a price discount level may be described as a “Discount Level” or “DL” followed by a letter and/or number to indicate the structure and amount of the discount. For example, the term “DL.A.1.n” may be used to describe one discount level, where “DL” may indicate that the term denotes a Discount Level, “A” may identify the Discount Level, “1” may describe the implementation tier, and “n” may represent a metric of the implementation's performance. This notation is provided for purposes of illustration within this application, but any method of naming tiers may be employed, including existing identification conventions in current computer languages and protocols.

FIG. 1 illustrates one embodiment of the invention. In one embodiment, a buyer first determines whether an item is an MBD-Covered item. If yes, the buyer is asked to choose an MBD level from among the offered Discount Levels. Upon choosing the MBD level the buyer is asked to confirm the MBD Terms. If the MBD Terms are confirmed, the buyer proceeds to purchase the item at the MBD-Discounted Price via YouBoard Licensed Checkout. This purchase becomes classified as a YouBoard Purchase Event.

If the Buyer does not confirm the MBD Terms, the buyer is asked to review and choose from among MBD options. If MBD Options are declined, then the purchase is made at the regular retail price, without an MBD Discount. If the same of a different MBD offer is chosen, then the buyer is asked again to confirm the MBD Terms. If the MBD terms are confirmed, then the purchase occurs as a YouBoard Purchase Event. If not, then the buyer may return to the MBD Option Screen. The buyer may exit the MBD process at any time to go straight to the regular checkout.

It should be noted that the selection and confirmation of the MBD level may be a simple process, with two additional clicks. There will be no additional screens to visit to fulfill the discount by choosing additional offers from companies on the next page, as is often the case with online incentive offers.

Similarly, this example assumes that the buyer will have registered previously with YouBoard. If not, then the buyer may have the option, during checkout, to use the entered information as their YouBoard registration.

A YouBoard member may associate their YouBoard account with their checkout from any e-commerce site. Notably, YouBoard may not perform fulfillment of orders, but rather may perform administration of the MBD Terms, which may include a passive marketing obligation that has been entered into, agreed or accepted by the YouBoard purchaser.

Upon becoming a YouBoard Purchase event, the purchase data is transmitted to YouBoard, and YouBoard checkout debits the sale price 0.6 percent as license fee for providing accounting and ongoing marketing services.

Such accounting may record various data items including but not limited to MBD purchase price, MBD level, MBD identifier, MBD terms, MBD fulfillment tracking, Attributed sales, Accumulated credits, QR Code, Loyalty programs, MBD Preferences information, and other items. The YouBoard Purchase Event will also post immediately as a YouBoard Post to associated social media accounts.

Subsequently, product use may trigger a YouBoard Usage Event, whereby the product use is similarly posted as a YouBoard Post to social media, and a YouBoard Banner for secondary, branded product marketing, which may include external display on the digital device for digital content, posting to YouBoard Hotspot Displays and local YouBoard pages, which displays may be furthered governed by rules as to size, frequency, duration, persistence, and animation. Such YouBoard posts may contain embedded links to facilitate direct purchase by Post viewers form the original merchant of sale or substitute merchants, and such purchases executed through a YouBoard post may be tracked and accrue to the YouBoard Poster's YouBoard account.

In one embodiment, a purchaser may be entitled to receive a discount based on the degree to which they may permit descriptive information about a copyrighted work, product, or other content to be displayed in their device so that it is visible to other users. Such display may include the “name,” where the title of the content and/or the name of the author, composer, developer, seller, or other creator is displayed, and/or “art,” additional graphic content such as a book cover, artist photograph, game logo, or other representation. Such art may be presented as a still image, a moving image, a montage, or some combination of these.

In one embodiment, such display may be on a display medium of any shape or size, covering substantially all of the device or some portion thereof, including more than one screen per device and more than one surface per device, and may include any form of display technology, including LCD, LED, ink screens, backlit screens, or any other form of display surface used now or in future, which are all incorporated herein by reference. In one embodiment a second visual display banner screen may be added to the back of one-sided tablets, smartphones, laptop computers, video screens, or other device, either as a modification to existing models or as a feature of new models, to perform such external display. In another embodiment, a passive display screen may be added to the back of a tablet computer or e-reader for fulfillment of external content description, but may not include interface means whether touch screen, keys, stylus, or any other form of input device. In another embodiment the multiple display configurations of an MCD may be used to display descriptive content information in any of the MCD's various device emulations or customized forms, including MCD arrays. MCDs are described in U.S. Pat. No. 7,782,274 filed on Jun. 9, 2006, which is incorporated herein by reference in its entirety. Optimized transmission of content streams to MCDs is disclosed in U.S. application Ser. No. 13/725,643 filed Dec. 21, 2012, which is herein incorporated by reference in its entirety.

MCD Arrays or other associations of devices, including multiple devices owned by one owner or among family members and able to access common libraries and other shared resources or assets, may be known as YouBoard Device Families, and may permit the execution of YouBoard Fulfillment on multiple devices simultaneously. For example, a YouBoard User who has agreed to post a screen saver on their e-reader may elect, or be given the option, to display the screen saver on all devices that have, for example, the same Kindle Library installed, or other such common product usage interface, when such devices are displaying screen savers and even when such devices are not being used primarily to interface with the product, though subject to such devices meeting other criteria for YouBoard Fulfillment, whether being in hotspot, or other location, where such is required. Such multiple device fulfillments may be compensable at a higher discount, either at the time of MBD election, or as an additional savings or credit issued by the MBD Seller for the MBD covered item and reflecting the increased value of the increased “throw weight” of multiple simultaneous YouBoard Fulfillments.

One beneficial consequence of such a pricing model may be that as a result of the economic incentive of available discounts, content descriptions may now be displayed externally by persons listening to audio-books, watching video, or playing a video game, which heretofore has not been the case.

In various embodiments, such Discount Levels may be applied at the time of purchase, and may be a single fixed amount or percentage at the time of purchase. In another embodiment such Discount Levels may be allocable or may be applied as accumulated credits based on actual performance during the listening or perusal of the copyrighted material. In another embodiment the user may choose to limit the external display of the e-book cover to only certain times, and in exchange may receive a pro-rated credit for a portion of the appropriate Discount Level.

In one embodiment, a purchaser may wish to buy an e-book through an online retail service from its individual product page or other link, and at the time of choice, be presented with a range of MBDs much as they might be presented with a range of styles and colors. In this example, however, rather than being asked to choose among different colors and sizes for an item sold at a single price, the purchaser may be presented with a range of options to purchase substantially the same product at different prices, and providing for different potential economic outcomes with respect to the purchase, based on the MBD chosen, signifying that the discount received at the time of purchase is not the final economic event tied to the purchase. In this example embodiment, the purchaser may make their selection via a YouBoard Purchase, and the e-book may be moved to their online cart.

In another embodiment, the purchaser may choose the item at a single price on its individual product page, and then be offered the discounts within the cart window, at the time of checkout. In another embodiment the purchaser may choose from available discounts for at least two books in the same cart, customizing the desired display options for each. In another embodiment the purchaser may select a non-display choice for certain books or all books in the order.

In another embodiment, the e-books that the user chooses to display externally may be listed in a “public library” of their purchases, which may be maintained on the retail site, may be collected on a social networking site. In another embodiment the postings may be links to purchase the same e-books from the same retail site.

In the social networking embodiment, at check out the purchaser may be provided with an option to publish the items being purchased on the purchaser's social network page in exchange for the discount. If the purchaser agrees, the merchant may provide an interface for the purchaser to enter his or her twitter, Facebook, etc., account info and agree to give the merchant access to those accounts for the purpose of posting a memo like “I purchased ______ on my Kindle ,” etc. The amount of the discount may be tied to the number of friends, the number of social networking sites that the purchaser agrees to publish on, etc. The posting may also be recurring, in which instance, the merchant may post such memo periodically. In certain instance, the purchaser may wish to delay the timing of the memo, for example, if one purchased the item as a gift. In this instance, the purchaser may be given an option to delay the post until after a specified date. The purchaser may also be given a discount according to the amount of time the memo maintains a prominent position in the purchaser's page, e.g., the top ten for a day, etc.

Importantly, the act of accepting a YouBoard discount may contain a thinking period, similar to the three days following a major financial transaction, during which the consumer has the option, at no cost beyond foregoing the YouBoard discount, to rescind their confirmed desire to exercise the YouBoard discount. In another embodiment a purchaser may retain the right to exercise a declined YB discount after the purchase, where such credits may have a declining value linked to time, where accumulated of declined MBD credits, may be exercised over next 10 business days at 75 percent of initial value, as direct merchandise credit usable at same merchant, then declining to 50 percent, or to zero after some period of time. This ability to preserve the option for an incentive discount may be seen as a retrospective consumer benefit that would be innovative as a result of YouBoard's technology, which permits items already purchased to be bought for less, in exchange for providing a marketing service. This may be seen as another innovative secondary level of efficiency available from YouBoard that has not previously been delivered to consumers.

In one embodiment, the cover art for a book may be displayed on a one-sided tablet, on the back of a two sided tablet, in a banner display, as a screen saver, or in any other form, and included with the display may be, for example, a UPC, 2D, QR or DataMatrix barcode (collectively, “Barcodes”) readable by a code scanner, which Barcode, among other purposes, may be scanned by another device user for preview or purchase. In this embodiment, the user who displays the content may be considered the “Marketing User,” with the device user who scans the barcode known as the “Consuming User.” In some embodiments the Barcode that is displayed may include a unique identifier for the marketing User who provided the Barcode, so that any preview or purchase of the content may be credited to the account of the marketing user. In some embodiments only purchases will qualify for the accrual of credits. Such credits may be redeemable for additional discount levels by the Marketing User.

In another embodiment the content being marketed may be a hybrid of a paperbound book with a digital cover, where the reader pages through the printed book in the traditional manner, but where the cover may be digitally printed or may include a digital display. Such digital display may include a Barcode unique to a Marketing User who was the original purchaser of the content, such that if the Barcode is scanned by a Consuming User and used to purchase the content in printed or in digital form, the credit accrues to the Marketing User whose hybrid book or other content served as the source of the purchase. In another embodiment the digitally displayed Barcode and non-expired rights or responsibilities associated with it may be transferred or associations altered to reflect the identity of the Consuming User, so that the user may act as Marketing User with respect to any subsequent previews or purchases that result from the now transferred or newly associated Barcode. In this manner the MBD Technology which may be applied to digital goods and services may also be applied to hard, physical, or other on-digital goods and services.

In another embodiment the content consists of a paperbound book printed on demand, with the purchaser offered the option, at the time of purchase, to include a Barcode unique to the buyer's identity, such that if the Barcode is scanned by another device user and used to purchase the content in printed or in digital form, the credit accrues to the Marketing User.

Examples of such discounts need not be limited to physically or digitally published content, but may extend to conventional paper books that may have a digital external cover, or any other physical product which may be stamped with an “Original Owner Barcode.” In one embodiment the Barcode may be scanned to acquire product information by a Consuming user for purposes of exploring purchase. In another embodiment such a Barcode may be of use in proving identity as the original purchaser of any product. In one embodiment the Barcode is stamped with ownership, model and serial number, and warranty information, so that a single scan may be used to request warranty service, or to provide complete information regarding make and model and year of manufacture for any other reason. In one embodiment an original owner Barcode may be used to request warranty recertification for purposes of resale, with the option to purchase the resale warranty made available to the secondary buyer.

In one embodiment, the digital device may be a single-sided tablet such as an existing Kindle or an iPad, where in exchange for making the book cover the default screen saver while the book is being read, a user may receive a discount in several forms, two examples of which may be described as “DL.A.1.0” and “DL.A.2.n,” respectively. In the example of “DL.A.1.0,” “DL.A” may indicate that the discount being applied is for displaying the content of a work as a screen saver, “1” may describe that the discount is being applied as a single markdown at the time of purchase, and “0” may indicate the absence of measurement information. In the example “DL.A.2.n,” “DL.A” may also indicate that the discount being applied is for displaying the content of a work as a screen saver, while “2” may indicate that the discount is being applied as a function of the amount of time the screen saver is actually displayed, and “n” may represent the measurement of that time.

In various embodiments YouBoard Commitments may be fulfilled through passive or automated triggering or activation of YouBoard Fulfillment actions. Such activations or triggers may occur as a result of digital product usage, service usage, or physical product usage, or as a result of contextual usage with respect to location, Wi-Fi or Internet or other electronic connectivity, or other criteria. Such YouBoard Fulfillment activations or triggers may be described, collectively, as YouBoard Activations.

For example, a user may open an eBook, triggering a YouBoard Activation of the YouBoard User's YouBoard Commitments with respect to such usage, which may include posting an exterior display of the eBook's cover art or name, posting such usage to social media sites such as Facebook, or posting to a local YouBoard online bulletin board or licensed display. For example, upon opening an eBook in, for example, a Starbucks Coffee Shop at an airport, a YouBoard User may display exterior evidence of the book being read which may be visible to other patrons of the Starbucks, as well as posting to any or all of Facebook, Twitter, other social media sites, as well as to the YouBoard bulletin board or display for the specific Starbucks location, any YouBoard Velocity Cloud that may be being maintained or may be being searched for all Starbucks locations in a given city, state, or worldwide, and to a YouBoard display or bulletin board or Velocity Cloud that may be displayed, being searched, or otherwise accessed for the airport, city, etc. Such collective postings may be described as YouBoard Postings.

In one embodiment the display of the YouBoard Fulfillment as a screen saver may generate a record of the beginning of that display, record its duration, and record its end. In another embodiment the record may simply note the moment that the screen saver is triggered for display. In one example, a DL may require that the screen saver be displayed at least once a day.

In another embodiment, credits may be applied or accumulated only for external content display that is simultaneous with connection to a public Wi-Fi hotspot or network. In this embodiment, the triggers of the screen saver may be logged, and a separate log may be maintained of Wi-Fi connections to, for example, a Starbucks Wi-Fi hotspot.

In one embodiment a computer program or an app may compare screen saver display times with Wi-Fi hotspot logins. If such events are not contemporaneous, the criteria for the DL may not be met. If such events are verified as contemporaneous, the DL software or app may either confirm that the criteria for a DL have been met, or may trigger a potential DL that required x number of public external content display events before being applied.

In one embodiment the DL software or app may transmit a verification message, which may be encrypted, to a central database for recording, accrual, and possible payment or issuance of a discount as a past for future credit. In another embodiment the DL software may record the data and be configured to transmit such data once every 24 hours, or at any other selected period.

In another embodiment, the digital device may consist of a two-sided tablet, with full-size screens on both sides of the device, and in exchange for displaying the book cover on the outer screen, facing away from the user, while the book is being read, the user may receive Discount Level B. In another embodiment, the user may choose to display the book cover while they are reading the e-book, and also as the default outward display of such two-sided tablet when the book is not being read, and in exchange receive Discount Level C.

In another embodiment, the device may be an MCD that is configurable as various device emulations including a single-sided tablet, a two-sided tablet, a laptop, a laptop with exterior screen surfaces capable of facing away from the user, or any other physical configuration. In this embodiment the DL criteria may require external display in some form, which may include public external display in a Wi-Fi hotspot, and the DL software or app may record events where the content's descriptive cover is the outer display when the MCD is configured as a two-sided tablet, or a dual exterior display, when the MCD is configured as a folded embodiment with the folded axis in a vertical position, such that a front and back cover may both be outwardly displayed. It may be seen that the position, location, or configuration of the displaying device may therefore affect the value of the external display or broadcasting in fulfillment of YouBoard Commitments, and may as a result be recorded as having satisfied such YouBoard Commitments, or earned credits for fulfillment of such YouBoard Commitments, at variable value measurements for accrual to the YouBoard User. For example, such YouBoard Obligation fulfillment events may be recorded identifying whether the external content display occurred when the MCD was configured as a smartphone, or as a flat screen viewer, and appropriate DLs either confirmed or applied.

In another embodiment a user may have the ability to upconvert an e-book or other content to display mode ability to activate current credits or to get future credits if the choice is made to so upconvert or to upconvert the means of YouBoard Fulfillment action, including potentially a provision for a relatively larger discount or YouBoard Benefit accrual if an e-reader is configured in vertical spine fold mode, permitting the display of both a front and back cover and/or the display of the YouBoard usage using surfaces capable of being pointed in more than one direction.

In various embodiments MBDs or DLs may have been exercised for physical products such as clothing, footwear, sporting equipment, transportation, or any other form of physical product. In these and similar embodiments, various methods may be employed to facilitate YouBoard Fulfillment, including methods and technologies designed to create, increase, or maximize the potential for subsequent YouBoard Postings of such product usage, as well as to create, increase, or maximize the potential for such use to occur in a context that may trigger YouBoard Activation. It should be reiterated that YouBoard Fulfillment is preferably a passive act triggered automatically upon product usage, and requiring no additional measures to be taken by the user of the product in order to fulfill their YouBoard Commitments.

In various embodiments, YouBoard Fulfillment with respect to physical products may be facilitated through the use of a YouBoard app or apps and a mobile phone, utilizing GPS technologies as well as Near Field Communications (“NFC”) and other recognition technologies. In one embodiment physical products purchased pursuant to YouBoard Discounts may have an electronic chip or be configured with a card or other device configured with an electronic signal that may be encoded with the agreed information regarding where and/or when the product was purchased and/or generic demographic information, regarding the purchaser, and/or specific individual information that the YouBoard User has agreed to share. In various embodiments such an identifying item may be used to register with the mobile phone or other reader upon a single use, upon entry to a sporting establishment, or any other time-dependent, location dependent, or proximity dependent contextual triggering event to which the purchaser has agreed. Such triggering events may include, but not be limited to, physical movement outside of, entering, or with proximity to a device or location, or a physical movement exceeding a particular parameter, which may include location, speed, or interrelationship to other objects. For example, a golf club purchased pursuant to an MBD may be so equipped to signal use, with such use based on movement, but configured so as not to trigger so long as the club remains within the golf bag, such that merely packing the golf bag may not trigger a YouBoard Posting. To be triggered, such use may require the golf club to be carried to a golf course or driving range, whereby GPS, NFC, or other technology may identify the use in a contextually appropriate location.

In previous embodiments, DLs may have been applied for various forms of external content display. In other embodiments, DLs may also be applied for external digital data announcements that may be recorded as data but may not appear in primary form as a visual display. For example, purchasers of content may be presented with additional choices to permit measurement of their content consumption, in a comparable manner to Amazon's proprietary Whispersync which is known and incorporated herein by reference. In this embodiment a DL software or app may record content consumption and then transmit it either at regular intervals, or only when connected to a Wi-Fi hotspot, and may require a confirmation prompt to permit transmission at some or all times.

In one embodiment such data may be assembled and processed to create local “Velocity Clouds,” which may be seen as a granular measurements assembled in modular building blocks of varying scales from the local hotspot, to neighborhoods, to membership organizations such as schools or universities, to entire cities, or any other desired region, providing information on what content is being consumed in what form, by how many people, or any other desired metric. Such data may be used to build local bestseller displays of various forms of content according to any desired scale, such that an airport may display the most widely read books, or watched videos in that location. Similarly, bestseller lists could be built in real-time for cities, differentiating communities from each other and making it possible for consumers to more readily identify with, for example, a representative list of what content, including books, periodicals, video, or audio, is being locally consumed. In this embodiment the smaller scale local Velocity Clouds may be seen as comparable to anecdotal beach settings, or airplanes, where consumers may traditionally have viewed the covers of books being read by others such that word of mouth may be shared and gather momentum. Through the employment of DLs, consumers may perceive an economic incentive to consent to their reading profile being anonymously measured, so they may see who is doing what here in the immediate local or other identified community.

Such Velocity Clouds may be seen as more specific and more vibrant analogues to bestseller rankings such as are maintained by, for example, Apple on iTunes, and Amazon on its site, in part because they may be defined as post-retail, most-consumed lists, rather than a simple proprietary record of purchases.

In substantially all embodiments, consumers would have the option to refuse measurement, or refuse to take advantage of DL incentives, and may keep their content consumption entirely private. In other embodiments certain forms of material, including material not considered suitable for persons under the age of 17, for example, may be exempted from the DL system, or may be prohibited from the DL system by local regulation.

In substantially all embodiments, YouBoard Fulfillment may be monitored pursuant to privacy regulations in the specific location where YouBoard Fulfillment may be occurring. YouBoard Discounts may be offered within the constraints of privacy regulations, including after the purchase date, and against the changing framework of such laws and regulations. If a particular form of YouBoard Fulfillment is declared in violation of applicable privacy rules and regulations after a YouBoard Discount has been accepted, then even though contractual consideration may have been exchanged, YouBoard may block the subsequent execution of such prohibited YouBoard Fulfillment, as well as blocking activation or triggering of such prohibited activity. Such compliance and monitoring functions may be seen as additional components of the services that YouBoard provides in exchange for receiving YouBoard License Fees.

In various embodiments, consumers may be able to interface with the Velocity Cloud data in some form, including selecting content for preview or purchase. For example, a consumer or other potential purchaser who is viewing an item listed or displayed within a Velocity Cloud may click on the item, and be guided to a page where the item may be displayed for sale or subscription by the original vendor or, in a case where an item may be for sale from multiple suppliers, from the user's preferred supplier, or from a supplier who may have paid a fee, or agreed to pay a fee upon sale, in order to be the YouBoard agent for such sale of such item. In such embodiments, a particular supplier of digital or physical products may have paid a fee to be listed first as a potential provider, or to be listed as the exclusive supplier for such product for purchase, or may have agreed to pay a fee to YouBoard for all such sales that are consummated as a result of viewing the item in the Velocity Cloud. Such fees may be determined according to the nature of the items being sold, subject to MBD Options, and may be in line with the license fees that have been previously described herein. Such sales may be described as YouBoard Velocity Sales.

In various embodiments, YouBoard Velocity Sales may additionally be subject to price protection, such that a purchaser who chooses to purchase a product or service through the process of viewing the product or service on a Velocity Cloud and subsequently clicking through to the appropriate seller or selling agent, may receive a warranty or guarantee or other commitment from YouBoard that the price they are being charged is the appropriate market price being charged to non-YouBoard purchasers, and that the YouBoard License Fee or other fee being paid by the YouBoard seller or selling agent is not being used to charge an excessive convenience tax to the purchaser. Such fees and determinations may be decided through the course of business in accordance with consumer protection laws, and the discussion herein is meant as a guide for one possible structure.

In some embodiments such preview or purchase may take the form of locally based subscriptions, whereby content is made available temporarily within a certain location, and then must either be purchased or access may be terminated. Such locally based subscriptions are referred to in U.S. patent application Ser. No. 13/053,163 filed Mar. 21, 2011, which is incorporated herein by reference.

YouBoard may also be an effective means to interface with local businesses. In addition to individual businesses posting YouBoards showing the most popular items being sold in their store, or in their restaurant, YouBoard may also show the items being reviewed for purchase by shoppers. Such additional levels of social data may be facilitated by the YouBoard platform, such that YouBoard may duplicate non-retail functions of social networks while adding the retail dimension as described via MBDs and LBS.

In another embodiment, YB Data may be used to generate various objective measures and measurements as indexes of YouBoard activity. Such measures may include but not be limited to representative YB Prices, YB Discount Levels, or any other definable dataset or metric of YB Data including within YB Velocity Clouds, and may collectively be described by the term YB Index(es), which may represent the objective or empirical metrics generated through the generation or use of YB Data. Such YB Index(es) may be further distinguished by the underlying data type being added as a definitional element. Such contemplated YB Index(es) may include but not be limited to: YB Price Index(es), YB Incentive Indexes, YB Discount Level Index(es), and YB Indexed Licensing Fees, among many other examples. Each YB Index may be further defined according to geographic location, industry type, group identification, social media demographic, age demographic, or any combination therefrom. YB Index(es) may be developed in varied frameworks, including by for business purposes, or crowd-sourced data points or datasets that emerge from the communal utilization of YouBoard's Velocity Clouds. Such YB Index(es) may become time series that may permit trends in their respective data areas to be tracked over time, including, for example, comparative price levels, comparative incentive levels, interrelationships between DLs exercised for various products and with respect to individually identified or generic MBDs, and any other data relationship.

YouBoard Velocity Clouds may also enable the rapid and spontaneous formation of social networks from people reading same book or using the same product or service, including the potential for user forums to be self-organizing, where a question about a particular product's use or benefit may be posed to a community of users who have posted the purchase of content, product, or service.

Notably, in various embodiments the value of the YB Index(es) may reflect market dynamics, “the dynamic, or changing, price signals that result from the continual changes in both supply and demand of any particular product or group of products. Market dynamics is a fundamental concept in supply, demand and pricing economic models.” (Investopedia) Such pricing signals result from the actions of buyers and sellers with differing opinions as to the desirable current price or expectations of the future price of a good or service based on their need to purchase, produce, consume, or provide the good or service. The price of a good or service is thus seen as embodying the expectations of many different decision makers with respect to the current and future value of such good or service, and objective market results are utilized by businesses and individuals for economic decisions and planning Since MBDs and present a buyer with a choice to either retain privacy rights or waive privacy rights for each MBD-covered purchase, one beneficial result of market dynamics with respect to Marketing-Based Discounts and any resulting YB Index(es) may be the identification and reporting of a valid price for individual consumer privacy, decided on a per-transaction basis by millions of consumers during their standard practice of economic activity, including the buying and selling of goods and services, and their individual decisions to either preserve or waive their privacy rights with respect to each individual MBD-Covered transaction or YouBoard event.

To the extent that such incentives and price mitigation opportunities are presented to businesses and organizations, similar, per-transaction privacy data may be generated by their economic activity.

For example, with respect to each MBD-covered transaction, there may be buyers who may choose to retain their privacy rights for that purchase, as well as buyers who may be willing to waive privacy rights to such purchase, for a certain fee. Economic research has shown that the degree of privacy individuals wish to retain varies according to the nature of a purchase, whether it is for generic items for which privacy has little value, such as meals, items that may be intended as a gift, or items for which the individual wishes to retain privacy, which may include personal items, or other items such as prescription drugs whose purchase is governed by existing privacy laws.

Similarly, sellers of such products may wish to gather data with respect to the buyer's identity, demographic profile, and general interests, in order to sell again to that buyer, or to sell to associates of the buyer, to others in the buyer's social sphere, including identifying those individuals who prove to be influencers of other purchasers. While the social influence concept is best understood through the vehicle of celebrity endorsements, economic research has revealed that smaller-scale influencers have measurable economic value as well, where particular individuals are proven to influence the buying decisions of others.

Consumer privacy is a central concern of the Internet and e-commerce, on an individual basis for consumers, and a strategic basis for Internet companies. Indeed, privacy is a central concern of the Internet era, serving as a significant focus for regulators and technology companies alike, with numerous investigations and enforcement actions by regulators with respect to companies such as Google and Facebook, with respect to privacy laws such as the Health Insurance Portability and Accountability Act (“HIPAA”), and contemplated regulations by government bodies with respect to “do not track” or “opt-in” or “do-not call” decisions and lists. The importance of privacy to Internet economic activity is also apparent in the evolving privacy policies of companies such as Facebook and e-commerce entities such as Amazon, where the proven value of a company's privacy pledges is placed in conflict with the company's desire to discover economically beneficial data about their customers, and the customers' desire, which may vary from individual to individual and from item to item, to retain or waive privacy. By guaranteeing a consumer certain rights, companies attempt to exploit their capabilities to extract information up to the limit of such rights, and an industry of privacy advocates has evolved that is dedicated to studying privacy policies, company performance with respect to their privacy policies, and any economic impact of such policies.

It has been an accepted view that privacy must be protected by government regulators based on privacy laws, and that new government approaches to privacy are required to meditate the conflict inherent in the opposed and conflicting interests of buyers and sellers with respect to each and every information or e-commerce transaction. Future privacy regulation is in fact cited as a risk factor confronting companies such as Facebook, whose value proposition is centered on their ability to provide services to users in exchange for gaining access to their personal information for purposes of economic exploitation, but with the proviso that the economic effect of such future regulation is unknown and cannot be quantified. As a result no economic value is assigned to the risks associated with matters of consumer privacy, and consumer privacy is treated as a macroeconomic concern, a matter for strategic but not tactical economic decisions, and over a longer, ambiguous time frame.

However, Marketing Based Discounts, YB Data, may offer the prospect of a real-time, market price for consumer privacy, and YB Index(es), by establishing and providing ongoing recording of benchmark values for consumer privacy across a wide range of e-commerce and Internet activity, may perform the beneficial service of commoditizing consumer privacy as a fungible financial index that may serve as a quantifiable element and basis for individual, corporate and government economic decisions and planning Furthermore, the existence of such a fluctuating market price, negotiated by buyers and sellers as a result of market activity, may provide a valid underlying basis for derivative instruments including over-the-counter financial derivatives, futures, options, options on futures, and any other security or instrument that may be based on or derived from an objective index, including serving as the basis for index funds and exchange traded instruments including exchange traded indexes. Such YB Index(es) may be allocated by product, industry, or other definable and quantifiable values including classifications currently used for defining existing products, industries, and all forms of transaction flows.

For companies active in the Internet or e-commerce, the availability of such indexes including YB Index(es) may enable the hedging of investments in certain activities that cannot be currently hedged, related to the changing value of consumer privacy, as well as the perception of privacy value as it may be linked to individual product purchases. Where YB incentives are an expense, a YB Provider may wish to hedge expected YB discounts.

For example, a consumer products company such as Proctor and Gamble that makes significant use of consumer incentives may desire to utilize YB technology and YB Data including YB Indexes for capital planning and economic projections related to various classes of products. In one embodiment such consumer companies may track the extent to which discounts are used across various product classifications, including yielding more valuable data that may be utilized by the consumer company with fewer restrictions to market to existing customers as well as to their spheres of influence. More pointedly, such consumer companies may be able to develop more precise understanding of the value of a particular incentive, including the long term self-amortization of certain incentive types, which is not currently a standard practice in the consumer industry. By providing an incentive that may reduce its cost to zero or may turn a profit as a result of technological efficiencies and socially influenced follow on sales, consumer products companies, among others, may significantly enhance their profitability while enlisting their customers to take on the role of marketing embedded in the YouBoard transaction, and which YouBoard facilitates as a follow-on economic benefit.

Futures markets evolved as a means of protecting the value of commodities that required time to deliver to market, and for which a current price, amplified by scarcity, may not be reflected on “market day” or the date of delivery, when the abundant availability of a commodity that may have been in great demand may cause the price to deflate precisely at the moment that the producer wishes to sell. Similarly, trends in consumer incentives or changing views regarding privacy itself with respect to certain classes of products, may presage similar fluctuations in future consumer incentive costs or sales revenues. Where such a relationship may be identified, a consumer products company may, by purchasing a YB Incentive linked derivative, may be able to lock in a profit based on an expected sales margin that it may anticipate may not be present as the consumer purchase cycle unfolds; or may choose to hedge its current incentive cost to promote early purchases against its predicted rise in income as a gift-giving season approaches. Equally, the same hedging capability may permit department stores, which may foresee significant sales reductions following a seasonal buying event such as Christmas, to sell a derivative product based on a perceived discount level that may need to be provided to move the most desirable amount of inventory during the slower period.

In this manner, YouBoard's mechanisms for delivering consumer incentives may enhance the ability of consumer products companies to provide not only YouBoard incentives but also more standard loyalty based or time-based incentives, and to hedge their incentive costs, which currently are a pure discount from the sales price.

YB Index(es) may additionally be valuable as metrics of consumer sentiment, analogous to the value of the Conference Board Consumer Confidence Index and other measures that are used as a means to gauge future consumer behavior, including as a means to support valuation models for social media and e-commerce companies in a marketplace where privacy, an acknowledged risk factor for such companies, develops a valid market price including providing evidence of directional trends, as well as an ongoing economic utility as a tangible measurement within consumer transactions. YB Data may hold the potential to create a unique new pool of data, namely a reliable “Big Data” pool of data that is equally granular and reliable on a microeconomic and macroeconomic basis, with consumer economic activity reported more regularly, facilitated consumer marketing for corporations, transparent revenue models for social media companies, and a lack of need to revise certain government metrics of consumer activity as frequently, and reduction in expenses on privacy enforcement and privacy regulation as related to consumer economic activity among a number of foreseeable consequences of the technology.

Among the various ways that Discount Levels and YB Incentives may see changing prices under market dynamics, YB privacy waivers may be timed to expire after a certain period, and not be perpetual, at a discount level that is different from the perpetual YouBoard advertising commitment for a particular product, content, or service. YouBoard postings may also be designed to be self-deleting, such that they are not readable afterward, or the contractual condition may be that the posting exists in analog mode, where it is not digitally recorded, or may be prohibited from digital use other than when active.

### REFERENCES

1. Acquisti, A., & Grossklags, J. (2005, January-February). Privacy and Rationality in Individual Decision Making. IEEE Security and Privacy, 3(1), 26-33.
2. Ahonen, T. (2012). Tomi Ahonen Almanac 2012—Mobile Telecoms Industry Review. Retrieved from http://www.tomiahonen.com/ebook/almanac.html
3. Brustein, J. (2012 Feb. 12). Start-Ups Seek to Help Users Put a Price on Their Personal Data. The New York Times.
4. Federal Reserve System. (2011 (Updated), Apr. 5). The 2010 Federal Reserve Payments Study. Retrieved from http://www.frbservices.org/files/communications/pdf/press/2010_payments_study.pdf
5. Kahneman, D. A. (1984). Choices, Values, and Frames. American Pscyhologist, 39(4).
6. Kahneman, D. T. (1979). Prospect Theory: An Analysis of Decision Under Risk. Econometrica 263291, 47(2), pp. 263-291.
7. Raice, S. (2012 Jul. 7). Facebook to Target Ads Based on App Usage. The Wall Street Journal, p. B3.
8. Shih-Fen S Chen, K. B.-C. (1998, Autumn) The effects of framing price promotion messages on consumers' perceptions and purchase intentions,. Journal of Retailing, 74(3), 353-372.
9. Temple, J. (2012 Feb. 2012). Mobile payment apps work to make wallets obsolete. SFGate/San Francisco Chronicle.
10. Tsai et al. (2010 Feb. 19). The Effect of Online Privacy Information on Purchasing Behavior: An Experimental Study. Information Systems Research, 22(2), 254-268.
11. Winkler, R. (2012 Feb. 17). Facebook and Google Are Risking an Invasion of Privacy From Regulators. The Wall Street Journal.
12. Zhan , J., & Rajamani, V. (2008, July). THE ECONOMICS OF PRIVACY, Privacy: People, Policy and Technology. International Journal of Security and its Applications, 2(3), 101-108.

What is claimed:

1. A computer system, comprising:
a merchant server interconnected to a public accessible network for receiving inquiries regarding purchasing of select products or services;
a merchant price processor for receiving inquiries regarding products or services for sale and implementing a price discount algorithm that reduces the retail price offered for the product or services in exchange for a pre-determined set of rights and/or obligations undertaken by said purchaser including rights to privacy, rights to publicity, rights to share content on social media outlets; and
a transaction processor for finalizing the purchase of said goods or services in accordance with the terms of purchase selected by the purchaser.
